(19) United States
(12) Patent Application Publication
(10) Pub. No.: US 2017/0195881 A1
(43) Pub. Date: Jul. 6, 2017

(54) INFORMATION PROCESSING SYSTEM, CONTROL METHOD, AND PROGRAM STORAGE MEDIUM

(71) Applicant: NEC Solution Innovators, Ltd., Tokyo (JP)

(72) Inventors: Yukio NISHIDA, Tokyo (JP); Noriyoshi HIROI, Tokyo (JP)

(21) Appl. No.: 15/315,316

(22) PCT Filed: May 18, 2015
(86) PCT No.: PCT/JP2015/002495

§ 371 Date: Nov. 30, 2016

(30) Foreign Application Priority Data
May 30, 2014 (JP) 2014-113004

(51) Int. Cl. H04W 12/06; H04W 8/24

(52) U.S. Cl. CPC H04W 12/06; H04W 8/24; H04W 88/02

(57) ABSTRACT

In order to enable a user's portable terminal to be authenticated by a method which is easy for the user, a control device of this information processing system uses terminal information transmitted from a portable terminal and containing a first identifier to generate a second identifier, which is returned to the portable terminal. The portable terminal presents the obtained second identifier in a visual manner. When the control device detects, on the basis of a photographic image from an imaging device which photographs a predetermined imaging area, that the generated second identifier has been presented visually by the portable terminal, the control device authenticates that portable terminal.

### TECHNICAL FIELD

The present invention relates to a technique to authenticate a portable terminal.

### BACKGROUND ART

Systems providing users with services include a system that utilizes users' portable terminals. An example of such system provides portable terminals with electronic books or other content services.

In general, such system provides services to the portable terminals that have been authenticated by the system. For example, in the authentication process for the system, a computer in the system obtains the account information (e.g., a combination of the user name and password) transmitted from the portable terminal, and then checks the obtained account information based on the account information that is registered in the system. When the computer in the system detects through the checking that the obtained account information is registered in the system, the computer authenticates the portable terminal that has transmitted the account information. The system provides services to the portable terminal that has been authenticated in this way. Examples of the systems that perform authentication using account information include, for example, the system disclosed in PTL 1.

### CITATION LIST

### Patent Literature

[PTL 1] Japanese Unexamined Patent Application Publication No. 2010-39569

### SUMMARY OF INVENTION

### Technical Problem

To use a system that performs authentication with account information (a user account), the user is required to enter the user account. Entering a user account takes time and effort of the user. In particular, in the case where the user is going to use the service temporarily, the user feels it troublesome that the user should perform such operation in spite of the temporary use.

The present invention has been designed for the purpose of solving the problem described above. Thus, a primary object of the present invention is to provide a technique to authenticate a user's portable terminal by a method that is easy for the user.

### Solution to Problem

To achieve the primary object of the present invention, an information processing system of the present invention includes:

a portable terminal that includes: a transmitting unit that transmits terminal information including a first identifier which is identification information; an obtaining unit that obtains a second identifier different from the first identifier; and a presenting unit that presents visually the second identifier;

an imaging device that captures an image of a predetermined imaging area; and

a control device that includes: a generating unit that generates the second identifier to identify the portable terminal which has transmitted the terminal information using the terminal information transmitted by the portable terminal; a replying unit that replays the second identifier generated by the generating unit to the portable terminal which has transmitted the terminal information; and a detecting unit that authenticates the portable terminal when detecting that the second identifier is visually presented by the portable terminal based on the image captured by the imaging device.

A portable terminal of the present invention includes:

a transmitting unit that transmits terminal information including a first identifier which is identification information to a control device which is a predetermined destination of communication;

an obtaining unit that obtains from the control device a second identifier different from the first identifier; and

a presenting unit that presents visually the second identifier obtained by the obtaining unit.

A control device of the present invention includes:

a generating unit that generates, using terminal information transmitted from a portable terminal, a second identifier to identify the portable terminal that has transmitted the terminal information;

a replying unit that replies the second identifier generated by the generating unit to the portable terminal which has transmitted the terminal information in which the second identifier is based on; and

a detecting unit that authenticates the portable terminal when detecting that the second identifier is visually presented by the portable terminal based on an image captured by an imaging device that captures the image of a predetermined imaging area.

A control method of the present invention includes:

generating, using terminal information transmitted from a portal terminal that transmits the terminal information including a first identifier which is identification information, a second identifier to identify the portable terminal which has transmitted the terminal information;

replying the second identifier to the portable terminal which has transmitted the terminal information which the second identifier is based on; and

authenticating the portable terminal when it is detected that the second identifier is visually presented by the portable terminal based on an image captured by an imaging device that captures the image of a predetermined imaging area.

A program storage medium of the present invention that stores a computer program causing a computer to execute:

generating, using terminal information transmitted from a portal terminal that transmits the terminal information including a first identifier which is identification information, a second identifier to identify the portable terminal which has transmitted the terminal information;

replying the second identifier to the portable terminal which has transmitted the terminal information which the second identifier is based on; and

authenticating the portable terminal when it is detected that the second identifier is visually presented by the portable terminal based on an image captured by an imaging device that captures the image of a predetermined imaging area.

The aforementioned primary object of the present invention is also achieved by the control method according to the present invention related to the information processing system of the present invention. The aforementioned primary object of the present invention is also achieved by the computer program that implements on a computer the information processing system and the control method according to the present invention, as well as by the program storage medium that stores the computer program.

### Advantageous Effects of Invention

According to the present invention, a technique to authenticate a user's portable terminal by a method that is easy for the user can be provided.

### BRIEF DESCRIPTION OF DRAWINGS

FIG. 1 is a block diagram schematically illustrating a configuration of an information processing system according to a first example embodiment of the present invention.

FIG. 2 is a block diagram schematically illustrating a configuration of the information processing system according to the first example embodiment.

FIG. 3 is a sequence diagram illustrating a flow of processes performed in the information processing system of the first example embodiment.

FIG. 4 is a block diagram schematically illustrating an example hardware configuration of the portable terminal.

FIG. 5 is a block diagram schematically illustrating an example hardware configuration of the control device.

FIG. 6 is a block diagram schematically illustrating an example configuration of the portable terminal according to the first example embodiment.

FIG. 7 is a block diagram schematically illustrating another example configuration of the portable terminal according to the first example embodiment.

FIG. 8 is a block diagram schematically illustrating a configuration of an information processing system according to a second example embodiment of the present invention.

FIG. 9A is an explanatory diagram illustrating an example connecting relation among a portable terminal, an imaging device, and a wireless access point.

FIG. 9B is an explanatory diagram illustrating another example connecting relation among a portable terminal, an imaging device, and a wireless access point.

FIG. 10 is an explanatory diagram illustrating process of comparing an address of a wireless device that is connected to a wireless access point with a first identifier of a portable terminal that has transmitted terminal information.

FIG. 11A is an explanatory diagram illustrating a technique that uses, as terminal positional information, intensity of radio wave received from a wireless access point.

FIG. 11B is an explanatory diagram illustrating an example of terminal positional information represented with intensity of radio wave.

FIG. 12 is a block diagram schematically illustrating a configuration of a control device forming part of an information processing system according to a fourth example embodiment of the present invention.

FIG. 13 is a diagram illustrating projection of an image on a table where the user is seated.

FIG. 14 is a block diagram schematically illustrating a configuration of an information processing system according to a fifth example embodiment of the present invention.

FIG. 15 is a block diagram schematically illustrating a configuration of a control device according to the fifth example embodiment.

FIG. 16 is a block diagram schematically illustrating a configuration of a control device forming part of an information processing system according to a sixth example embodiment of the present invention.

FIG. 17 is a block diagram schematically illustrating a configuration of a portable terminal forming part of an information processing system according to a seventh example embodiment of the present invention.

FIG. 18 is an explanatory diagram illustrating an example user operation detected by the control device according to the seventh example embodiment.

FIG. 19 is an explanatory diagram illustrating a configuration of an information processing system according to an eighth example embodiment of the present invention.

### DESCRIPTION OF EMBODIMENTS

Example embodiments of the present invention will be described with reference to the drawings.

### First Example Embodiment

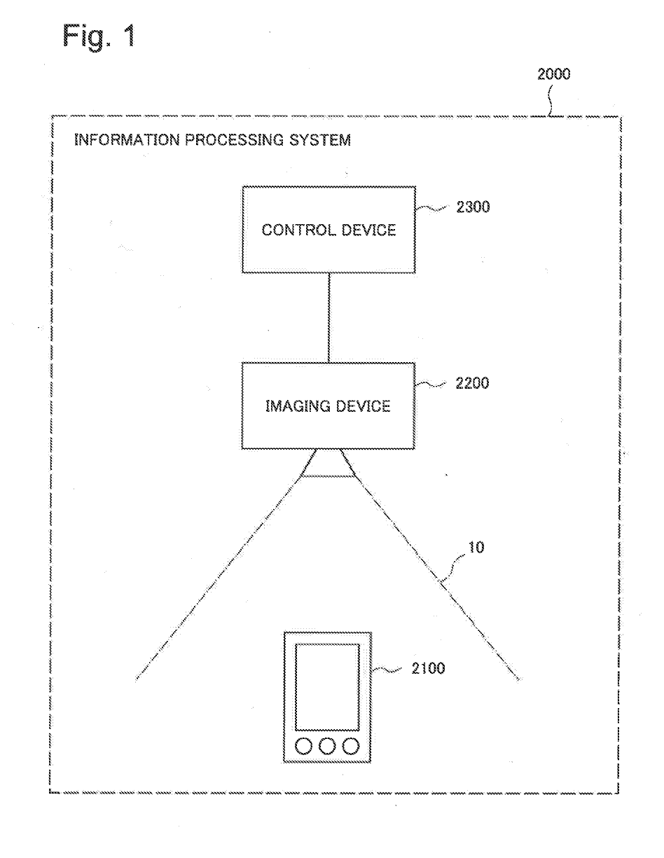

FIG. 1 is a diagram conceptually illustrating an information processing system 2000 according to a first example embodiment. The information processing system 2000 includes a portable terminal 2100, the imaging device 2200, and a control device 2300. The imaging device 2200 has a function to capture an image of a portable terminal 2100 present within an imaging area 10 and output data of the image. The control device 2300 has a function to detect whether the portable terminal 2100 is present within the imaging area 10 based on the data outputted by the imaging device 2200. Note that a single portable terminal 2100 or a plurality of portable terminals 2100 may be present in the imaging area 10.

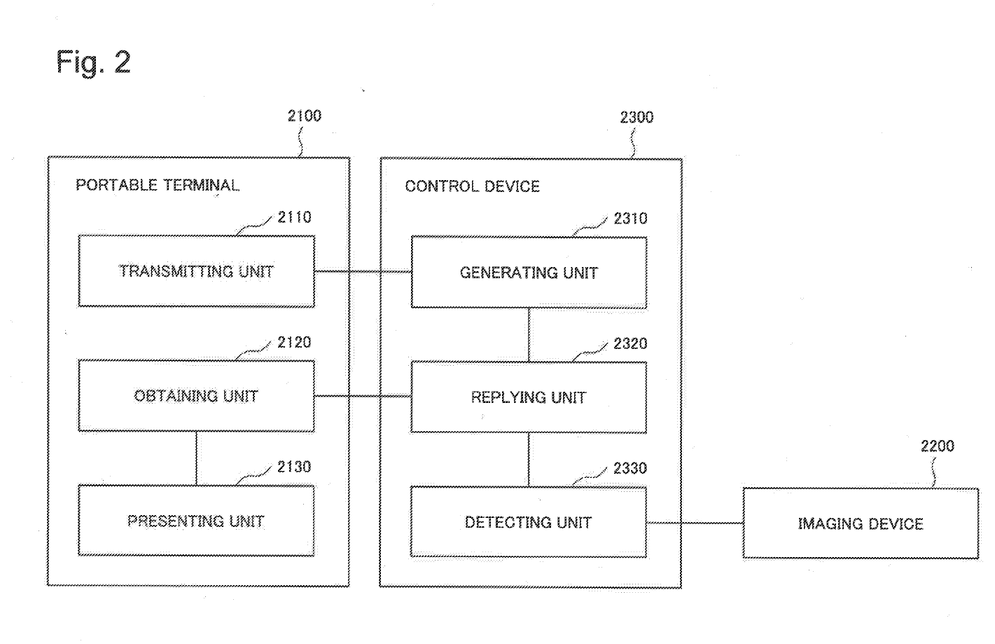

FIG. 2 is a block diagram schematically illustrating configurations of the portable terminal 2100 and the control device 2300 which form part of the information processing system 2000 according to the first example embodiment. Note that each block in FIG. 2 represents a functional component, not a hardware component.

The portable terminal 2100 includes a transmitting unit 2110, an obtaining unit 2120, and a presenting unit 2130. The transmitting unit 2110 transmits terminal information to the control device 2300. The terminal information includes a first identifier of the portable terminal 2100. The first identifier is information on identifying the portable terminal 2100. For example, the first identifier may be the Internet Protocol (IP) address, media access control (MAC) address, or universally unique identifier (UUID) of the portable terminal 2100.

The obtaining unit 2120 obtains a second identifier of the portable terminal 2100. The second identifier is generated by the control device 2300. The second identifier is information on identifying each of one or more portable terminals 2100 being present within the imaging area 10 of the imaging device 2200. The presenting unit 2130 visually presents the second identifier obtained, using a display device (not illustrated) for example.

The control device 2300 includes a generating unit 2310, a replying unit 2320, and a detecting unit 2330. The generating unit 2310 obtains the terminal information transmitted from the portable terminal 2100, and then generates a second identifier of the portable terminal 2100 which has transmitted the terminal information using the terminal information obtained. The replying unit 2320 replies the second identifier generated by the generating unit 2310 to the portable terminal 2100 which has transmitted the terminal information. The detecting unit 2330 obtains an image captured by the imaging device 2200, and, detects the second identifier which is visually presented by the portable terminal 2100 from the image obtained by the imaging device 2200.

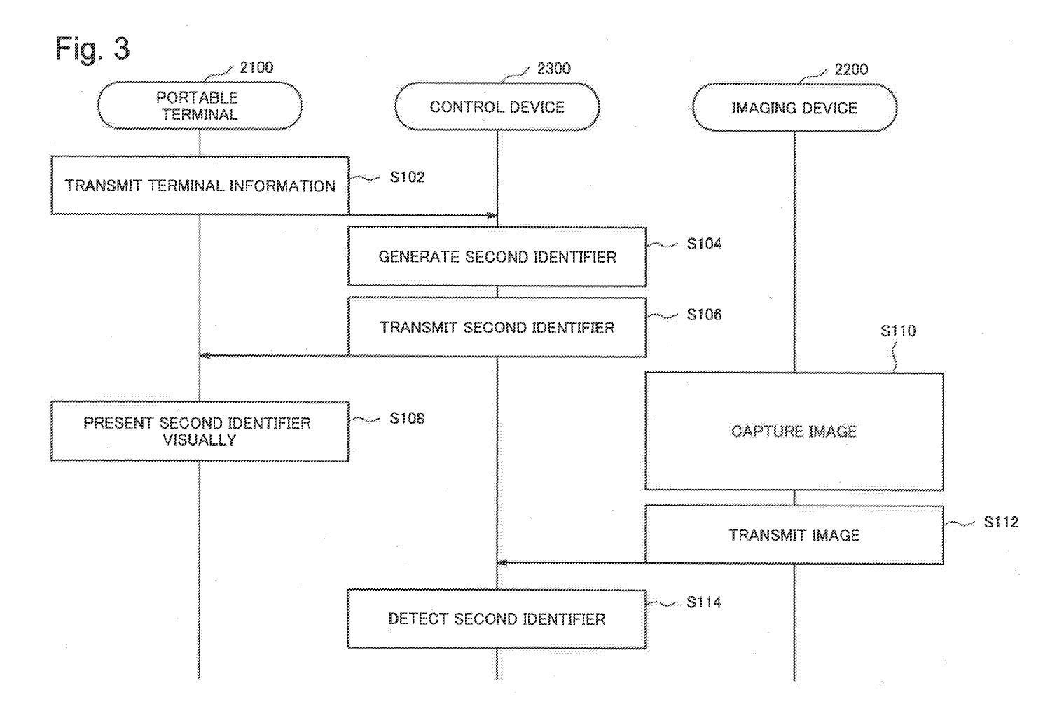

FIG. 3 is a sequence diagram illustrating a flow of processes performed in the information processing system 2000 of the first example embodiment. In Step S102, the transmitting unit 2110 in the portable terminal 2100 transmits the terminal information. The generating unit 2310 in the control device 2300 obtains the terminal information transmitted by the transmitting unit 2110. In Step S104, the generating unit 2310 generates a second identifier of the portable terminal 2100 using the terminal information. In Step S106, the replying unit 2320 replies the second identifier to the portable terminal 2100 which has transmitted the terminal information.

In Step S108, the presenting unit 2130 in the portable terminal 2100 receives and visually presents the second identifier. Meanwhile, in Step S110, the imaging device 2200 captures an image of the imaging area 10. This imaging process is performed for the purpose of obtaining the second identifier which is visually presented by the portable terminal 2100 in Step S108, and thus the image is captured at a time when the second identifier presented is available for imaging. For example, upon receipt of information on notifying that the second identifier has been transmitted from the control device 2300, the imaging device 2200 determines when to capture an image based on the information.

In Step S112, the imaging device 2200 transmits data of captured image captured by the imaging device 2200 to the control device 2300. Alternatively, the control device 2300 may acquire the data of captured image from the imaging device 2200 by accessing the imaging device 2200, instead of transmission of the data of captured image from the imaging device 2200 to the control device 2300. In Step S114, the detecting unit 2330 detects the second identifier from the captured image which has been obtained.

The information processing system 2000 according to the first example embodiment provides effects described below by performing the aforementioned processes. The detecting unit 2330 detects the second identifier which has been visually presented by the portable terminal 2100 from the image captured by the imaging device 2200. Although the portable terminal 2100 presents the second identifier, the second identifier will not appear in the captured image if the portable terminal 2100 is located outside the imaging area 10 of the imaging device 2200. Accordingly, if the portable terminal 2100 is outside the imaging area 10, the second identifier is not detected by the detecting unit 2330. Therefore, the control device 2300 can detect whether the portable terminal 2100 which has transmitted the terminal information is present within the imaging area 10 of the imaging device 2200.

Suppose here that “any portable terminal” is going to be detected from an image. This would be achieved by some general method such as “detecting whether the captured image contains an image representing a general portable terminal in terms of shape”. However, such method fails to detect a specific portable terminal, such as “the portable terminal 2100 which has transmitted the terminal information to the control device 2300”.

In contrast, in the information processing system 2000 of the first example embodiment, the control device 2300 generates the second identifier of the portable terminal 2100 which has transmitted terminal information, and replies the second identifier to the portable terminal 2100. Then, the control device 2300 detects the second identifier visually presented by the portable terminal 2100 from the captured image received from the imaging device 2200, thereby detecting a portable terminal 2100 present within the imaging area 10. These processes allow the control device 2300 to detect, not just “any portable terminal”, but a specific portable terminal which is “the portable terminal 2100 which has transmitted the terminal information to the control device 2300 and is present within the imaging area 10 of the imaging device 2200”.

Accordingly, the information processing system 2000 of the first example embodiment can authenticate the portable terminal 2100 using the method by which “the portable terminal 2100 is authenticated based on whether the portable terminal is located in a predetermined place”. The “predetermined place” refers to “the imaging area 10 of the imaging device 2200”. For example, this authentication method achieves such form of service operation as: “providing services to the portable terminal 2100 requesting for the services when the portable terminal 2100 is located in the predetermined place”.

By the way, one possible method of authenticating the portable terminal 2100 located in the predetermined place may be an authentication method which uses positional information inputted by the user. However, this authentication method takes time and effort of the user, such as operating the portable terminal 2100 to transmit the positional information regarding the portable terminal 2100 to the control device 2300.

In contrast, the information processing system 2000 of the first example embodiment authenticates the portable terminal 2100 located within the imaging area 10 without requiring the user to input account information or positional information. In other words, the information processing system 2000 of the first example embodiment can perform the authentication process on any portable terminal 2100 located in the predetermined place with ease and without taking time and effort of the user.

In addition, the individual functional units 2110, 2120, and 2130 included in the portable terminal 2100 can be implemented by using various hardware pieces included in a general-purpose portable terminal. That is, it is unnecessary to install special hardware pieces into the portable terminal 2100 forming part of the information processing system 2000 of the first example embodiment. Thus, the information processing system 2000 can be put to practical use without special time and effort to produce the portable terminal 2100 which can be applied to the system, thereby avoiding an increase in cost and time for producing the portable terminal 2100.

The following describes in detail the portable terminal 2100 and the control device 2300 which form part of the information processing system 2000 of the first example embodiment.

Each of the functional units 2110, 2120, 2130, 2310, 2320 and 2330 included in either the portable terminal 2100 or the control device 2300 is implemented by combining hardware and software (for example, combining a processor with a computer program controlling the processor). Alternatively, each of the functional units 2110, 2120, 2130, 2310, 2320 and 2330 may be implemented by hardware (for example, electronic circuitry forming circuits for implementing predefined functions).

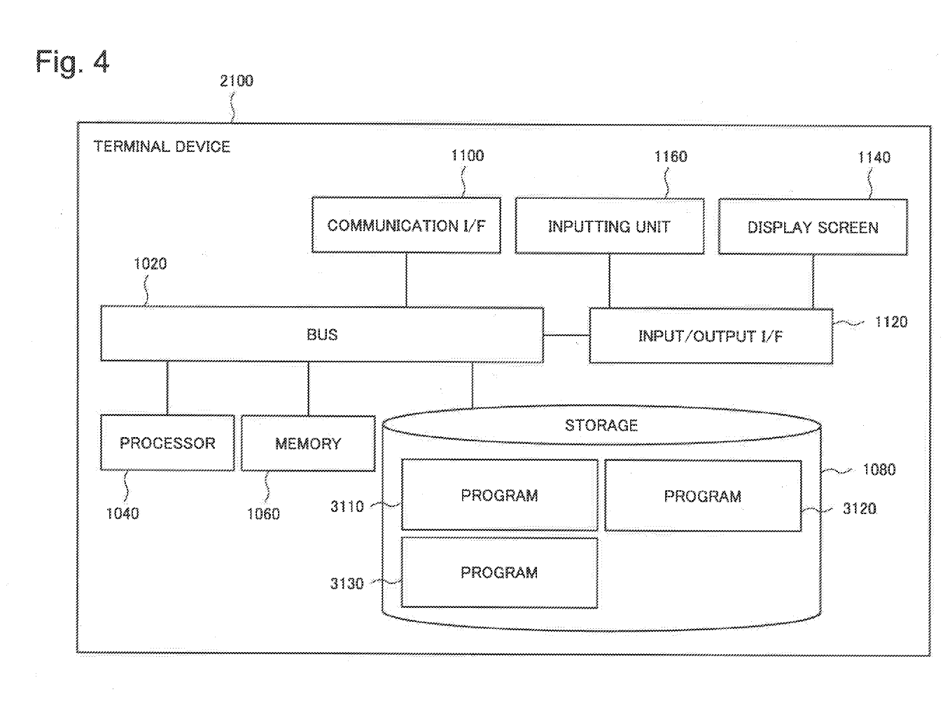

FIG. 4 is a block diagram schematically illustrating an example of hardware pieces forming the portable terminal 2100. The portable terminal 2100 is a portable device such as a mobile phone or tablet PC (personal computer).

The portable terminal 2100 includes a bus 1020, a processor 1040, a memory 1060, a storage 1080, a communication interface (communication I/F) 1100, an input/output interface (input/output I/F) 1120, a display screen 1140, and an inputting unit 1160.

The bus 1020 is a data transmission line through which the processor 1040, the memory 1060, the storage 1080, the communication interface 1100, and the input/output interface 1120 transmit/receive data to/from one another. Note that the method of connecting the processor 1040, the memory 1060, the storage 1080, the communication interface 1100, and the input/output interface 1120 to one another is not limited to bus connection.

The communication interface 1100 is an interface implementing communications with external units via a network or the like. The communication interface 1100 herein includes a network interface connecting to a wireless line. The input/output interface 1120 is an interface connecting the processor 1040 and other components to an input/output device (for example, the display screen 1140 and the inputting unit 1160) located inside or outside the portable terminal 2100.

The display screen 1140 displays images and the like. The inputting unit 1160 is an inputting apparatus such as a touch panel, a keyboard, or operation buttons. If the inputting unit 1160 is the touch panel, the display screen 1140 and the inputting unit 1160 are formed to be integrated with each other. The input/out device is not limited to the display screen 1140 or the inputting unit 1160.

The memory 1060 is a storage device (storage medium), such as random access memory (RAM) or read only memory (ROM). The storage 1080 is a storage device (storage medium), such as a memory card, a hard disk device, or a solid state drive (SSD). The storage 1080 may be a memory such as RAM or ROM.

The storage 1080 stores, for example, the computer programs (hereinafter also called programs for short) 3110, 3120, and 3130, which implement the functions of the transmitting unit 2110, the obtaining unit 2120, and the presenting unit 2130, respectively, included in a portable terminal 2100.

The processor 1040 is an arithmetic processing unit, such as a central processing unit (CPU) or a graphics processing unit (GPU). The processor 1040 implements the transmitting unit 2110, the obtaining unit 2120, and the presenting unit 2130 by executing the programs 3110, 3120, and 3130, respectively, which are stored in the storage 1080. The processor 1040 reads the programs 3110, 3120 and 3130 from the storage 1080, writes the programs 3110, 3120 and 3130 to the memory 1060, and then executes the programs 3110, 3120 and 3130 present in the memory 1060. Alternatively, the processor 1040 may execute the programs 3110, 3120 and 3130 present in the storage 1080 without writing them to the memory 1060.

The hardware configuration of the portable terminal 2100 is not limited to the configuration depicted in FIG. 4. For example, the programs 3110, 3120 and 3130 may be stored in the memory 1060 rather than residing on the storage 1080. In this case, the storage 1080 may be omitted in the hardware configuration of the portable terminal 2100.

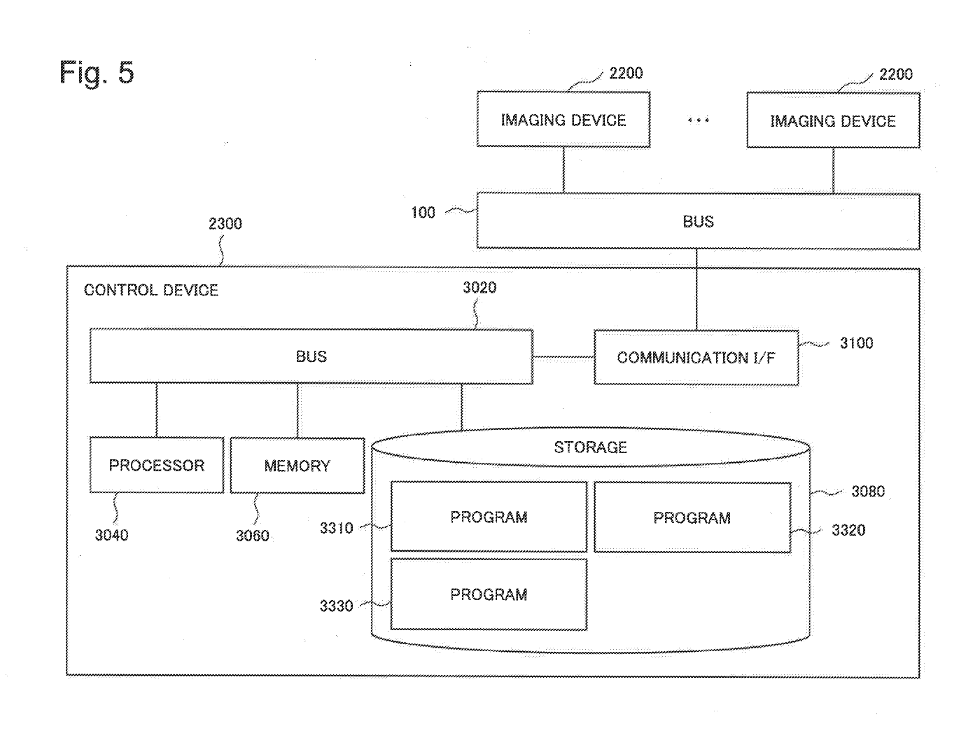

FIG. 5 is a block diagram schematically illustrating a hardware configuration of the control device 2300. The control device 2300 is an information processing device such as a server, a PC or a portable terminal. The control device 2300 is connected to the imaging device 2200 via the bus 100. The imaging device 2200 is a device for capturing still or moving image such as a camera. The bus 100 is a transmission line through which data is transmitted between the imaging device 2200 and the control device 2300. However, the method of connecting between imaging device 2200 and the control device 2300 is not limited to bus connection. For example, the imaging device 2200 may be connected to the control device 2300 via a network. Although FIG. 5 illustrates a plurality of imaging devices 2200, there may be only one imaging device 2200.

The control device 2300 includes a bus 3020, a processor 3040, a memory 3060, a storage 3080 and a communication interface (communication I/F) 3100.

The bus 3020 is a data transmission line through which the processor 3040, the memory 3060, the storage 3080 and the communication interface 3100 transmit/receive data to/from one another. Note that the method of connecting the processor 3040, the memory 3060, the storage 3080, and the communication interface 3100 to one another is not limited to bus connection. The communication interface 3100 is an interface implementing communications with outside. If the control device 2300 connects to a network via a wired line, the communication interface 3100 includes a network interface connecting to the wired line. In addition to connecting to the imaging device 2200, the bus 100 may further be connected to an external input device (not illustrated). The external input device may be, for example, an operation device such as a mouse or remote controller, or a reader such as the one for reading information on a radio frequency (RF) tag or on an integrated circuit (IC) chip compliant with Near Field Communication (NFC).

The memory 3060 is a storage device (storage medium) such as random access memory (RAM) or read only memory (ROM). The storage 3080 is a storage device (storage medium) such as a memory card, a hard disk device or a solid state drive (SSD). The storage 3080 stores the computer programs (hereinafter also called programs for short) 3310, 3320 and 3330 which implement the functions of the generating unit 2310, the replying unit 2320 and the detecting unit 2330, respectively, included in the control device 2300. The hardware configuration of the control device 2300 is not limited to the configuration depicted in FIG. 5.

As with the processor 1040 in the portable terminal 2100, the processor 3040 is an arithmetic processing unit such as a central processing unit (CPU) or a graphics processing unit (GPU). The processor 3040 implements the generating unit 2310, the replying unit 2320 and the detecting unit 2330 by executing the programs 3310, 3320, and 3330, respectively, which are stored in the storage 3080. As with the processor 1040 in the portable terminal 2100, the processor 3040 reads the programs 3310, 3320 and 3330 from the storage 3080, writes them to the memory 3060, and then executes the programs 3310, 3320 and 3330 present in the memory 3060. Alternatively, the processor 3040 may execute the programs 3310, 3320 and 3330 present in the storage 3080 without writing them to the memory 3060.

The following describes in detail the individual functional units implemented by the processor 1040 in the portable terminal 2100 and the processor 3040 in the control device 2300.

As described above, the transmitting unit 2110 in the portable terminal 2100 has the function to transmit the terminal information including a first identifier to the control device 2300. The first identifier represents information on identifying the portable terminal 2100 such as an IP address, MAC address or UUID, as mentioned above. If any of such addresses utilized for communications via a network is used as the first identifier, the first identifier acts as the address of the portable terminal 2100 to which the information processing system 2000 provides services. This enables the information processing system 2000 to manage the first identifier and the address of the portable terminal 2100 with a single data piece, resulting in a reduced amount of information compared with the case where the first identifier is different from the address of a portable terminal 2100 to which services are provided.

The transmitting unit 2110 may transmit the terminal information at a predetermined suitable timing selected from various possible timings. By way of example, it is assumed here that the portable terminal 2100 has an application program installed thereon, the application program being dedicated to using services provided by the information processing system 2000. In this example, the transmitting unit 2110 is activated and transmits the terminal information at a time when, for example, the user starts the dedicated application program. Alternatively, the transmitting unit 2110 may transmit the terminal information at a time when the portable terminal 2100 detects vibration caused by a user operation such as placing the portable terminal 2100 on a table, while the aforementioned dedicated application program is already started. Alternatively, the transmitting unit 2110 may transmit the terminal information at a time when a predetermined operation (for example, pressing a predetermined button) is carried out on the portable terminal 2100, while the aforementioned dedicated application program is already started.

The timing when the terminal information is transmitted is not limited to those described above. For example, if the information processing system 2000 provides services in the form of Web services, the transmitting unit 2110 may transmit the terminal information at a time when the portable terminal 2100 logs in through a general browser or the like to the Web site that provides such Web services. Concerning how the transmitting unit 2110 transmits the terminal information, the transmitting unit 2110 may transmit the terminal information to the control device 2300 by, for example, sending to the control device 2300 an e-mail message with the terminal information attached.

In addition, the transmitting unit 2110 may transmit the terminal information through any of a variety of possible communication lines. For example, the transmitting unit 2110 transmits the terminal information by using wireless communication lines such as 3rd generation (3G) lines, Long Term Evolution (LTE) lines or WiMAX (Worldwide Interoperability for Microwave Access) lines. Alternatively, the transmitting unit 2110 may transmit the terminal information by, for example, using a dedicated communication line provided for the information processing system 2000. In this case, the portable terminal 2100 connects to the dedicated line by connecting to a wireless access point that can be connected to the dedicated line. The process of connecting the portable terminal 2100 to a wireless access point may be performed manually by the user of the portable terminal 2100 or handled by the processor 104 according to a dedicated application program as described above.

The presenting unit 2130 has a function to visually present the second identifier that has been obtained by the obtaining unit 2120 from the control device 2300. The presenting unit 2130 starts presenting the second identifier at a predetermined timing selected from a variety of possible timings. For example, the presenting unit 2130 starts presenting the second identifier visually at a time when the obtaining unit 2120 obtains the second identifier from the control device 2300.

Alternatively, the presenting unit 2130 may start presenting the second identifier at a time when a change in the state of the portable terminal 2100 is detected. Examples of such change may include input of predetermined information to the portable terminal 2100, inclination of the portable terminal 2100, or vibration of the portable terminal 2100. Examples of user operations causing the portable terminal 2100 to vibrate may include tapping on the portable terminal 2100 or placing it on a table. If the presenting unit 2130 is to start presenting the second identifier based on the change in inclination or vibration of the portable terminal 2100, the portable terminal 2100 includes a sensor for detecting a change in inclination or vibration (e.g., an acceleration sensor).

In addition, the presenting unit 2130 may determine whether to start presenting the second identifier based on the angle of inclination added to the portable terminal 2100 or the level of vibration caused to the portable terminal 2100. For example, the presenting unit 2130 starts presenting the second identifier when the angle of inclination added to the portable terminal 2100 exceeds a predetermined angle, or when the vibration caused to the portable terminal 2100 exceeds a predetermined level. In other words, the presenting unit 2130 does not present the second identifier as long as the angle of inclination added to the portable terminal 2100 is equal to or less than the predetermined angle or the level of vibration caused to the portable terminal 2100 is equal to or less than the predetermined level. The aforementioned predetermined angle or level of vibration is stored in, for example, the memory 1060 in the portable terminal 2100.

The presenting unit 2130 also stops presenting the second identifier at a predetermined suitable timing selected from a variety of possible timings. For example, the presenting unit 2130 stops presenting the second identifier at a time when it detects a lapse of a predetermined time since the start of presenting the second identifier. Alternatively, the presenting unit 2130 may stop presenting the second identifier at a time when a predetermined change in the state of the portable terminal 2100 is detected. Examples of such change may include input of predetermined information to the portable terminal 2100, inclination of the portable terminal 2100, or vibration of the portable terminal 2100. The operation serving as a basis for determining when the presenting unit 2130 should stop presenting the second identifier may or may not be the same as that for determining when the presenting unit 2130 should start presenting the second identifier. For example, the presenting unit 2130 may start presenting the second identifier at a time when it detects vibration of the portable terminal 2100, and then stop presenting the second identifier at a time when it detects vibration of the portable terminal 2100 again. Alternatively, the presenting unit 2130 may start presenting the second identifier at a time when it detects inclination of the portable terminal 2100, and then stop presenting the second identifier at a time when it detects vibration of the portable terminal 2100.

The presenting unit 2130 visually presents the second identifier in a predetermined way selected from a variety of possible ways. The following describes two specific examples.

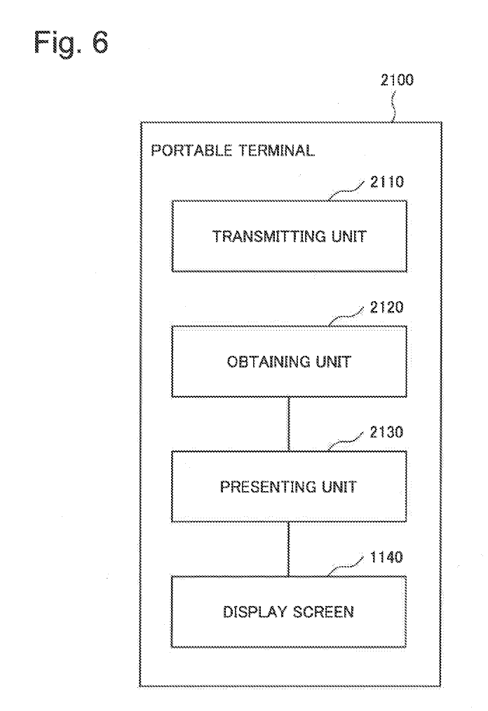

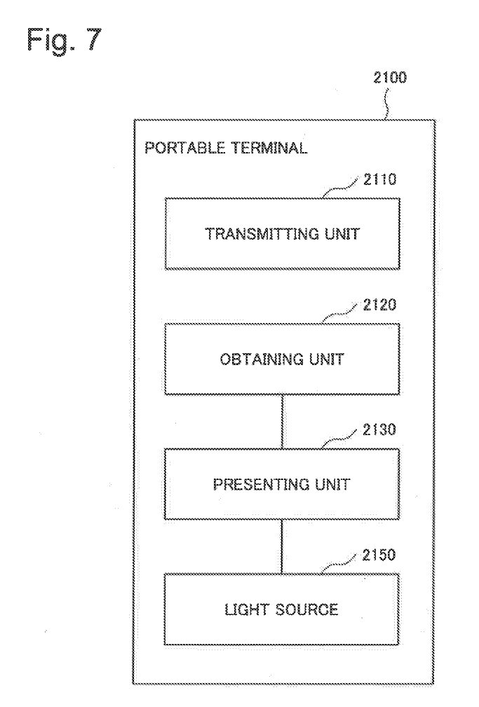

For example, the presenting unit 2130 may display a character string or an image representing the second identifier on the display screen 1140 included in the portable terminal 2100. In this case, the presenting unit 2130 is connected to the display screen 1140 as illustrated in FIG. 6.

The image representing the second identifier may be an image directly representing the second identifier, or may be an image representing a symbol into which the second identifier is coded. Supposing that the second identifier is a number string “1234”, “the image directly representing the second identifier” refers to an image that visually shows the number string “1234”. The “symbol into which the second identifier is coded” refers to a bar code, a two-dimensional code, or the like, to which the second identifier is converted.

In the case where the second identifier is displayed on the display screen 1140 in the form of the coded symbol, the process of coding the second identifier may be performed in the control device 2300 or in the portable terminal 2100. If second identifiers are coded in the control device 2300, the portable terminal 2100 obtains coded second identifiers from the control device 2300. If second identifiers are coded in the portable terminal 2100, the portable terminal 2100 obtains uncoded second identifiers from the control device 2300.

The presenting unit 2130 may display the whole second identifier at once on the display screen 1140, or may display sequentially, for example, the number string “1234”, in units of predetermined digits (e.g., a single digit).

Instead of using the display screen 1140, the presenting unit 2130 may be connected to a light source 2150, which is included in the portable terminal 2100, to visually present the second identifier using the light source 2150. For example, the presenting unit 2130 may visually present the second identifier by controlling the light source 2150 so as to blink in a pattern based on the second identifier. The light source 2150 may be, for example, a light source (e.g., a backlight) forming part of the display screen 1140, or may be a light source disposed separately from the display screen 1140 (e.g., a light emitting diode (LED), or a light source disposed for visible light communication).

The following describes a specific example of information presentation with combinations of turned-on and turned-off states of such light source 2150. For example, the presenting unit 2130 expresses a bit representing a value of 1 with the turned-on state (ON) of the light source 2150, and a bit representing a value of 0 with the turned-off state (OFF) of the light source 2150. By way of example, it is assumed here that the second identifier is a four-bit value, “1001”. In this example, the presenting unit 2130 visually presents the second identifier by controlling the light source 2150 so as to blink (light on and off) in the order of “ON, OFF, OFF, ON”. Other ways of visually presenting a second identifier using the light source 2150 may include, for example, expressing a signal in a predetermined format, e.g., Morse code signal, using the light source 2150.

In the case where light sources forming the display screen are used as the light source 2150, the presenting unit 2130 may use, as the light source presenting the second identifier, all the light sources forming the display screen or part of the light sources forming the display screen. Alternatively, the presenting unit 2130 may visually present the second identifier by independently lighting on or off the individual light sources, the light sources corresponding to a plurality of areas into which the display screen 1140 is divided. For example, on the display screen 1140 divided into four areas 1 to 4, the presenting unit 2130 may visually present the second identifier “1001” by turning light states of the areas 1 to 4 “ON, OFF, OFF, ON”, respectively. In this case, the presenting unit 2130 can present a plural-bit value of the second identifier simultaneously by using the light source 2150.

Alternatively, the presenting unit 2130 may visually present the second identifier by displaying images different from each other on the display screen 1140, for example, one image corresponding to “1” and the other image corresponding to “0” for presenting the second identifier “1001”. More specifically, the presenting unit 2130 represents a bit having a value of 1 by displaying a lighter image on the display screen 1140, while representing a bit having a value of 0 by displaying a darker image on the display screen 1140. However, the difference between images is not limited to brightness; any images visually different from each other may be used.

In addition, the presenting unit 2130 may present the second identifier using colors of the light source 2150. By way of example, it is assumed that the presenting unit 2130 represents 3-bit information using three light sources 2150 each emitting a light whose color is different from one another. It is assumed here that the three light sources 2150 each emit one of three distinct colors: red, green, and blue. It is further assumed that a red light represents that the third bit is 1, a green light represents that the second bit is 1, and a blue light represents that the first bit is 1. Then, the presenting unit 2130 presents the second identifier “100” by turning on the blue light source 2150, while turning off the red and green light sources 2150. For the second identifier “101”, for example, the presenting unit 2130 presents the second identifier by turning on both the blue and red light sources 2150, while turning off the green light source 2150.

If these three light sources 2150 are placed close to one another to produce lights, the image captured by the imaging device 2200 will show a color such as purple produced by combining these color lights being emitted. Thus, if the image of a purple light is captured, the detecting unit 2330 detects that the information “101” is presented.

To present the second identifier having a four-or-more-bit value using a method similar to the ones described above, a plurality of sets of three light sources 2150 with distinct colors are used. For example, by using three sets of such light sources 2150, the presenting unit 2130 can present the second identifier having a 9-bit value.

By the way, in view of security, the presenting unit 2130 may present the second identifier in such a way as to prevent third parties from identifying it. For example, in the case where the second identifier is represented by its image shown on the display screen 1140, the presenting unit 2130 represents the image of the second identifier as part of another image. In another example, the control device 2300 may give control to synchronize the portable terminal 2100 with the imaging device 2200, so that the imaging device 2200 can capture the image of the portable terminal 2100 at a time when the presenting unit 2130 presents the second identifier. In this example, the presenting unit 2130 may shorten a time period when the second identifier is displayed. In still another example, the presenting unit 2130 can present the second identifier in view of security, by using any of various techniques including, for example, the technique for showing a security code instantaneously and intermittently on a still or moving image. Such techniques are already known, and thus their detail descriptions are omitted.

The imaging device 2200 may capture the image at, for example, predetermined intervals (e.g., 30 frames/sec) irrespective of operations of the portable terminal 2100. In this case, the imaging device 2200 captures the image irrespective of when the presenting unit 2130 in the portable terminal 2100 presents the second identifier. This allows, for example, the detecting unit 2330 in the control device 2300 to obtain the second identifier presented by the portable terminal 2100 by analyzing all the images captured by the imaging device 2200. Alternatively, the detecting unit 2330 may analyze some of the images captured by the imaging device 2200 based on the information it obtains representing that the replying unit 2320 has transmitted the second identifier to the portable terminal 2100. For example, the detecting unit 2330 may analyze the captured images that fall under a time period starting from transmission of the second identifier by the replying unit 2320 to the portable terminal 2100 until a lapse of a predetermined time to obtain the second identifier presented by the portable terminal 2100. The imaging device 2200 stores images it took in a storing unit located inside or outside the imaging device 2200. In the case where some of the captured images are analyzed as described above, the imaging device 2200 stores the captured images each being associated with time information.

The imaging device 2200 may capture the image in a time period that reflects consideration for a time when the presenting unit 2130 in the portable terminal 2100 presents the second identifier. For example, the imaging device 2200 starts capturing the image upon receipt of notification from the control device 2300 that the replying unit 2320 has transmitted the second identifier. In this case, the imaging device 2200 captures the image in a predetermined time period. Information about a time period when image is captured may be given to the imaging device 2200, or may be transmitted by the control device 2300 to the imaging device 2200. The control device 2300 may output the information notifying that the second identifier has been transmitted exactly at, or slightly prior to, the time when the replying unit 2320 transmits the second identifier.

The imaging device 2200 may transmit the image to the control device 2300, or the control device 2300 may access the storing unit storing the image to obtain it.

The generating unit 2310 in the control device 2300 generates the second identifier in view of the considerations described below. It is presumed that a plurality of portable terminals 2100 may possibly be present within the imaging area 10 of the imaging device 2200. Thus, the data size of the second identifier is determined so that each portable terminals 2100 present within the imaging area 10 can have the second identifier different from each other. For example, supposing that there are five portable terminals 2100 within the imaging area 10 of the imaging device 2200, then the data size of the second identifier needs to be 3 bits or more. This is because data in 2 bits or less can only express up to 4 different values.

The generating unit 2310 can generate the second identifier using any of a variety of methods. For example, the generating unit 2310 inputs the first identifier of the portable terminal 2100 to a predetermined function (e.g., a hash function) and use its output value as the second identifier. In another example, the generating unit 2310 may generate a random number and use the generated number as the second identifier. However, methods for generating the second identifier are not limited to the ones described above.

In the case where the single control device 2300 obtains images captured by a plurality of imaging devices 2200, the number of second identifiers has to be equal to or greater than the total number of portable terminals 2100 which are present within any imaging area 10 of the imaging devices 2200. For example, supposing that there are five portable terminals 2100 within the imaging area 10 of a first imaging device 2200 while there are four portable terminals 2100 within the imaging area 10 of a second imaging device 2200, then the number of second identifiers should be nine. Thus, this example requires the data size of the second identifier to be 5 bits or more.

The generating unit 2310 can determine the data size of the second identifier using any of a variety of methods. For example, the generating unit 2310 estimates the number of portable terminals 2100 that can possibly use the information processing system 2000 almost at the same time, and determines the data size of the second identifier based on the estimation. By way of example, it is assumed that a user seated at a table uses the information processing system 2000. It is further assumed that the imaging device 2200 has an appropriate imaging area, as the imaging area 10, covering the top face of the table. Then, the generating unit 2310 estimates the number of portable terminals 2100 that can possibly be present within the imaging area 10 of a single imaging device 2200 based on the size of the table and the number of chairs placed at the table. In addition, the generating unit 2310 calculates the number of portable terminals 2100 which can use the information processing system 2000 almost at the same time based on the estimated value and on the number of imaging devices 2200 included in the information processing system 2000. Finally, the generating unit 2310 determines the data size of the second identifier so as to generate identifiers being different from one another, as second identifiers, where the number of identifiers is equal to or greater than the calculated number of portable terminals.

However, methods for determining the data size of the second identifier are not limited to the ones described above.

The detecting unit 2330 in the control device 2300 detects the second identifier presented by the portable terminal 2100 by analyzing images captured by the imaging device 2200. For example, in the case where the second identifier is presented in the form of the character string on the display screen 1140, the detecting unit 2330 detects the second identifier represented as the character string from the image by performing the process of character recognition on the captured image. The detecting unit 2330 may identify an area representing the display screen of the portable terminal 2100 by analyzing the captured image, and then perform the process of character recognition on the identified area only. Reducing an image area for the character recognition can decrease the number of errors and failures in detection as well as the time and calculation amount required for the processing. In particular, if the image captured by the imaging device 2200 includes an image which is likely to be mistaken as the second identifier, the detecting unit 2330 preferably performs the process of character recognition on only the area showing the display screen 1140 of the portable terminal 2100 as described above.

In the case where the second identifier is shown in the form of an image, the detecting unit 2330 detects the second identifier represented as the image by processing the image provided by the portable terminal 2100. As with the aforementioned character recognition, the detecting unit 2330 may detect an area showing the display screen 1140 of the portable terminal 2100 from the image captured by the imaging device 2200, and then detect the second identifier represented as an image by processing only the image of the detected area.

In the case where the second identifier is presented in a pattern of blinks made by the light source 2150, the detecting unit 2330 detects the second identifier by analyzing a plurality of images in time series that have been captured by the imaging device 2200 at predetermined intervals. In this case, the detecting unit 2330 determines in what order the light source 2150 has been caused to blink based on the time interval between operations of turning the light source 2150 on or off by the presenting unit 2130 (hereinafter called the blinking interval) and on the time interval between operations of capturing images by the imaging device 2200 (hereinafter called the imaging interval). The detecting unit 2330 may already know the blinking interval of the light source 2150, or may determine the blinking interval based on information provided by the portable terminal 2100. In the case where the detecting unit 2330 already knows the blinking interval of the light source 2150, the blinking interval data is stored in a storing unit included in the control device 2300.

In the case where the portable terminal 2100 provides data on the blinking interval of the light source 2150 to the detecting unit 2330, the portable terminal 2100 may, for example, transmit the blinking interval data along with the terminal information. The control device 2300 then analyzes captured images using the transmitted blinking interval data. If the blinking interval of the light source 2150 is different among portable terminals 2100, the blinking interval data is preferably provided by each portable terminal 2100 to the control device 2300.

### Second Example Embodiment

A second example embodiment of the present invention will now be described. In descriptions about the second example embodiment, identical reference symbols are used for components identical to those of the information processing system according to the first example embodiment, and duplicate descriptions concerning the identical components are omitted.

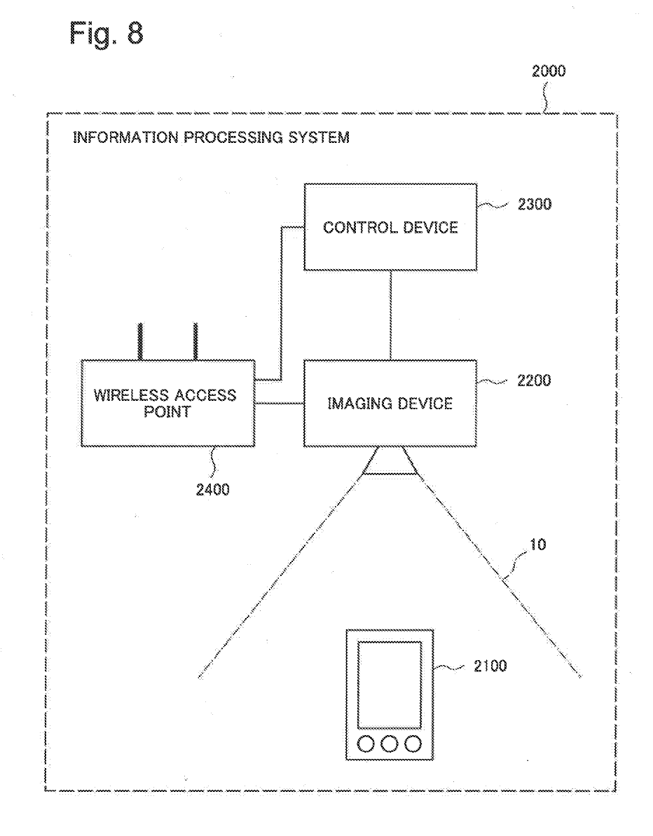

FIG. 8 is a diagram conceptually illustrating an information processing system 2000 of the second example embodiment. In addition to the configuration of the first example embodiment, the information processing system 2000 of the second example embodiment includes a wireless access point 2400. The wireless access point 2400 has a function to communicate wirelessly with a device that has wireless communication functions (hereinafter simply called wireless device) and is present within an area where wireless communication is enabled, so as to connect the wireless device to an information communication network such as a local area network (LAN). In the second example embodiment, the wireless access point 2400 has a function to connect the portable terminal 2100 present within a wireless communication enabled area to the control device 2300. The wireless access point 2400 is connected to the imaging device 2200. The wireless communication enabled area provided by the wireless access point 2400 is positioned and sized to include the imaging area 10 of the imaging device 2200.

In the second example embodiment, the data size of the second identifier generated by the generating unit 2310 in the control device 2300 is determined based on the number of wireless device which can be present within the wireless communication enabled area provided by the wireless access point 2400. The wireless device may only consist of portable terminal 2100 which use the information processing system 2000, or may include not only portable terminal 2100 but also a wireless device that does not use the information processing system 2000.

The following describes in detail the information processing system 2000 of the second example embodiment. According to the second example embodiment, the generating unit 2310 further includes a function to identify which wireless access point 2400 is connected by wireless communication to the portable terminal 2100 which transmitted the terminal information obtained by the generating unit 2310.

The generating unit 2310 further includes a function to detect the number of wireless device that is connected by wireless communication to the identified wireless access point 2400. The generating unit 2310 generates the second identifier whose data size is determined in view of the detected number of wireless device.

The detecting unit 2330 of the second example embodiment detects the imaging device 2200 which is communicatively connected to the wireless access point 2400 detected by the generating unit 2310, and then obtains the captured image from the imaging device 2200. Then, the detecting unit 2330 detects the second identifier of the portable terminal 2100 from the obtained image, as with the cases described above.

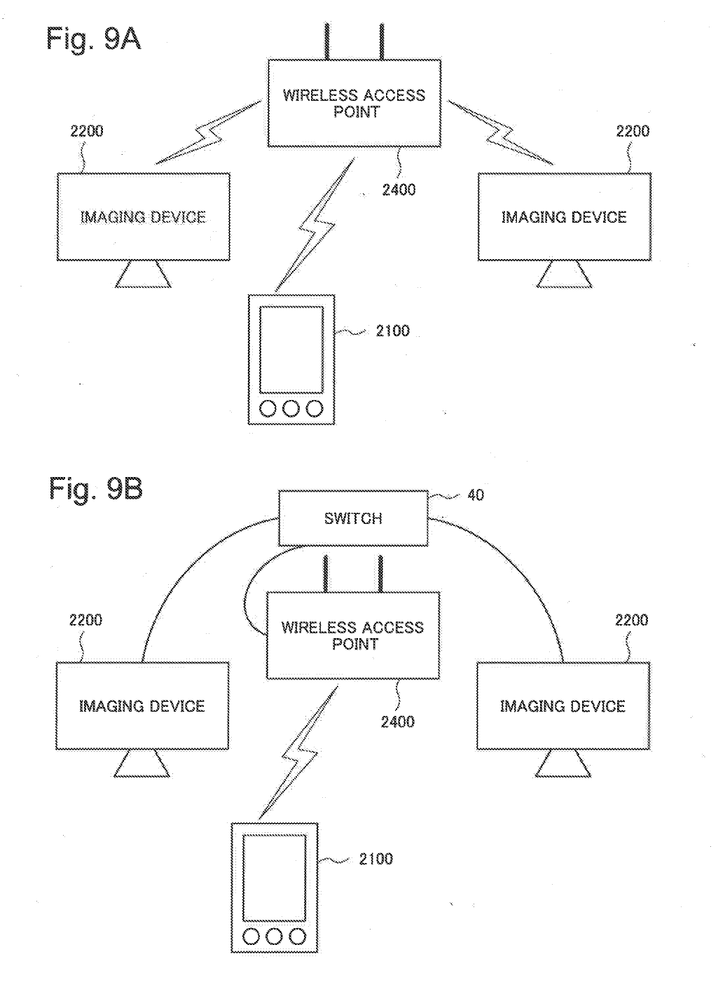

The imaging device 2200 can be connected to the wireless access point 2400 by any of a variety of methods. Specific examples of such connection methods are illustrated in FIGS. 9A and 9B.

The example in FIG. 9A shows that imaging devices 2200 as well as the portable terminal 2100 are directly connected to the wireless access point 2400 by wireless communication. The example in FIG. 9B shows that the portable terminal 2100 is connected to the wireless access point 2400 by wireless communication, while imaging devices 2200 are connected to the wireless access point 2400 via a switch 40 by wired communication. The switch 40 includes a configuration for switching between the enabled and interrupted states of communication between the imaging device 2200 and the wireless access point 2400.

Although the example in FIG. 9B shows that imaging devices 2200 are connected to the wireless access point 2400 via the switch 40, the imaging device 2200 may be connected to the wireless access point 2400 by wired communication without passing through the switch 40.

The wireless access point 2400 connected to the portable terminal 2100 can be identified by any of a variety of methods. For example, before transmitting the terminal information to the generating unit 2310 in the control device 2300 by using the wireless access point 2400, the portable terminal 2100 can create the terminal information that includes information on identifying the wireless access point 2400 to which the portable terminal 2100 is connected. The information on identifying the wireless access point 2400 may be, for example, the MAC address or Service Set Identifier (SSID) of the wireless access point 2400. The generating unit 2310 uses such information to identify the wireless access point 2400 connected to the portable terminal 2100 that has transmitted the terminal information.

Alternatively, the generating unit 2310 may identify the wireless access point 2400 connected to the portable terminal 2100 by using the first identifier included in the terminal information which has been received from the portable terminal 2100. By way of example, it is assumed here that at a maximum of one wireless access point 2400 is arranged in a single sub network in the information processing system 2000. It is further assumed that the IP address of the portable terminal 2100 is used as the first identifier of the portable terminal 2100. Then, the generating unit 2310 can identify the wireless access point 2400 connected to the portable terminal 2100 by detecting the sub network to which the portable terminal 2100 belongs based on the IP address of the portable terminal 2100. In this case, a storing unit installed in the control device 2300 stores information representing the IP address and subnet mask of each wireless access point 2400, and the generating unit 2310 can identify the wireless access point as described above by using such information.

In addition, the generating unit 2310 detects the number of portable terminal 2100 being present within the wireless communication enabled area of the identified wireless access point 2400, and then generates the second identifier of the data size which is determined based on the detected number of portable terminal.

The number of portable terminal 2100 being present within the wireless communication enabled area of the wireless access point 2400 (in other words, the number of wireless device which is using the information processing system 2000) can be detected by any of a variety of methods. By way of example, it is assumed that the wireless access point 2400 is an access point dedicated to the information processing system 2000. In other words, a wireless device (that is, the portable terminal 2100) on which a dedicated application to use the information processing system 2000 is started is the only device that is allowed to connect to the wireless access point 2400. In this example, the number of wireless devices connected to the wireless access point 2400 represents the number of portable terminal 2100 connected to the wireless access point 2400. In this way, the generating unit 2310 can detect the number of portable terminal 2100 connected to the wireless access point 2400 by detecting the number of wireless device connected to the wireless access point 2400.

In the case where wireless devices other than the portable terminal 2100 are also permitted to connect to the wireless access point 2400, the generating unit 2310 identifies any portable terminal 2100 which is using the information processing system 2000 from among the wireless devices connected to the wireless access point 2400. For example, the transmitting unit 2110 has a configuration (function) to transmit the terminal information at a time when connected to the wireless access point 2400. Thus, the generating unit 2310 can identify as portable terminal 2100 those wireless devices that are connected to the wireless access point 2400 and have transmitted terminal information. Specifically, general wireless access points have the ability to detect the MAC address of each connected wireless device. The generating unit 2310 checks information about the MAC address of a wireless device connected to the wireless access point 2400 against information about the MAC address included in the terminal information that has been transmitted to the control device 2300. As a result of the checking, the generating unit 2310 can extract the portable terminal 2100 from the wireless devices connected to the wireless access point 2400.

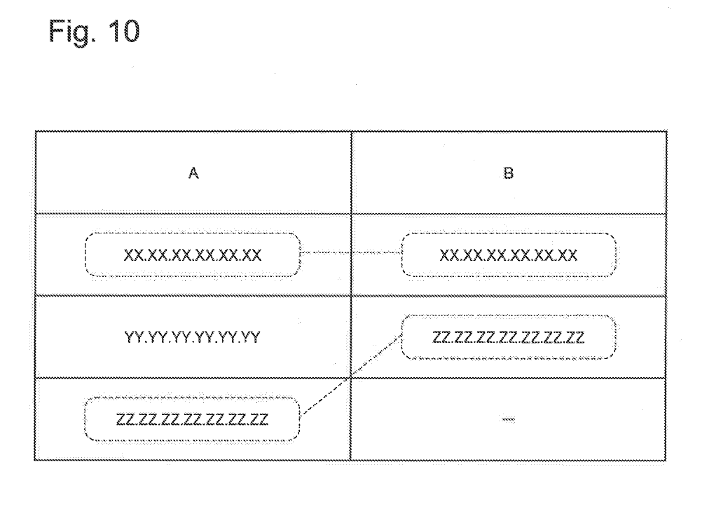

FIG. 10 shows a table of comparison between MAC addresses of the wireless devices connected to the wireless access point 2400 and first identifiers of the portable terminals 2100 which have transmitted terminal information. In the example in FIG. 10, MAC addresses of the wireless devices connected to the wireless access point 2400 are listed in the column A, while MAC addresses, i.e., first identifiers, of the portable terminals 2100 that have transmitted terminal information are listed in the column B. In the example in FIG. 10, two MAC addresses: “XX.XX.XX.XX.XX.XX” and “ZZ.ZZ.ZZ.ZZ.ZZ.ZZ” among those of the wireless devices connected to the wireless access point 2400 correspond to the first identifiers of the portable terminals 2100 that have transmitted terminal information. In this example, the generating unit 2310 detects that two of the wireless devices connected to the wireless access point 2400 are the portable terminals 2100 that are using the information processing system 2000. Note that the table in FIG. 10 is illustrated for the purpose of explanation only, the generating unit 2310 need not create a table as shown in FIG. 10.

The information processing system 2000 of the second example embodiment has a configuration for authenticating the portable terminal 2100, as with the information processing system of the first example embodiment, thereby providing the effect of authenticating the portable terminal 2100 by a method that is easy for users. In addition, the information processing system 2000 of the second example embodiment detects the number of portable terminal 2100 being present within the imaging area 10 of the imaging device 2200 by using the wireless access point 2400 having the wireless communication enabled area whose position and size are similar to those of the imaging area 10. As a result, the generating unit 2310 in the control device 2300 can generate the second identifier of a suitable data size that depends on the number of portable terminal 2100. Supposing that it is impossible to detect the number of portable terminal 2100 being present within the imaging area 10, then the number of portable terminal 2100 should be estimated to be relatively high, and accordingly the second identifier would be generated in a relatively large data size based on such estimated value. Compared with such case, the configuration of the second example embodiment allows the second identifier to be smaller in data size. As a result, the control device 2300 can decrease the time and calculation amount needed for creating the second identifier as well as the time for transmitting and receiving the second identifier. Furthermore, the portable terminal 2100 can decrease the time and calculation amount needed for visually presenting the second identifier.

### Third Example Embodiment

A third example embodiment of the present invention will now be described. In descriptions about the third example embodiment, identical reference symbols are used for components identical to those of the information processing system 2000 according to the first example embodiment, and duplicate descriptions concerning the identical components are omitted.

In addition to the configuration of the first example embodiment, the information processing system 2000 according to the third example embodiment includes a configuration for utilizing positional information regarding the portable terminal 2100 and positional information regarding the imaging device 2200.

In the third example embodiment, the transmitting unit 2110 in the portable terminal 2100 obtains its terminal positional information, namely positional information regarding the portable terminal 2100, adds the terminal positional information to the terminal information, and transmits the terminal information to the control device 2300. The generating unit 2310 in the control device 2300 determines a candidate of the imaging device 2200 that can capture the image of the portable terminal 2100 that has transmitted the terminal information, by using the terminal positional information included in the obtained terminal information, as well as using information representing the position of the imaging device 2200 (imaging device positional information). Then, the generating unit 2310 identifies the portable terminal 2100 located near the imaging device 2200 determined to be a candidate. Finally, the generating unit 2310 generates the second identifier of a data size determined in view of the number of the identified portable terminal 2100.

The configuration of the information processing system 2000 of the third example embodiment except the above-described difference is similar to that of the first example embodiment, and thus descriptions about the similar configuration are omitted.

The following describes specific examples of the terminal positional information regarding the portable terminal 2100. The terminal positional information regarding the portable terminal 2100 may be, for example, information on identifying the absolute position of the portable terminal 2100 such as coordinate information provided by a global positioning system (GPS). In the case where GPS coordinate information is used as the terminal positional information, the portable terminal 2100 includes a receiver for receiving GPS signals.

Alternatively, the terminal positional information may represent the position of the portable terminal 2100 based on a relative positional relation between the portable terminal 2100 and another device. For example, the portable terminal 2100 may use the intensity of a radio wave received from a wireless access point as the information representing a position relative to the wireless access point. If a plurality of wireless access points are present around the portable terminal 2100, the portable terminal 2100 uses the intensity of radio wave received from the plurality of wireless access points as the positional information representing a position relative to the respective wireless access points.

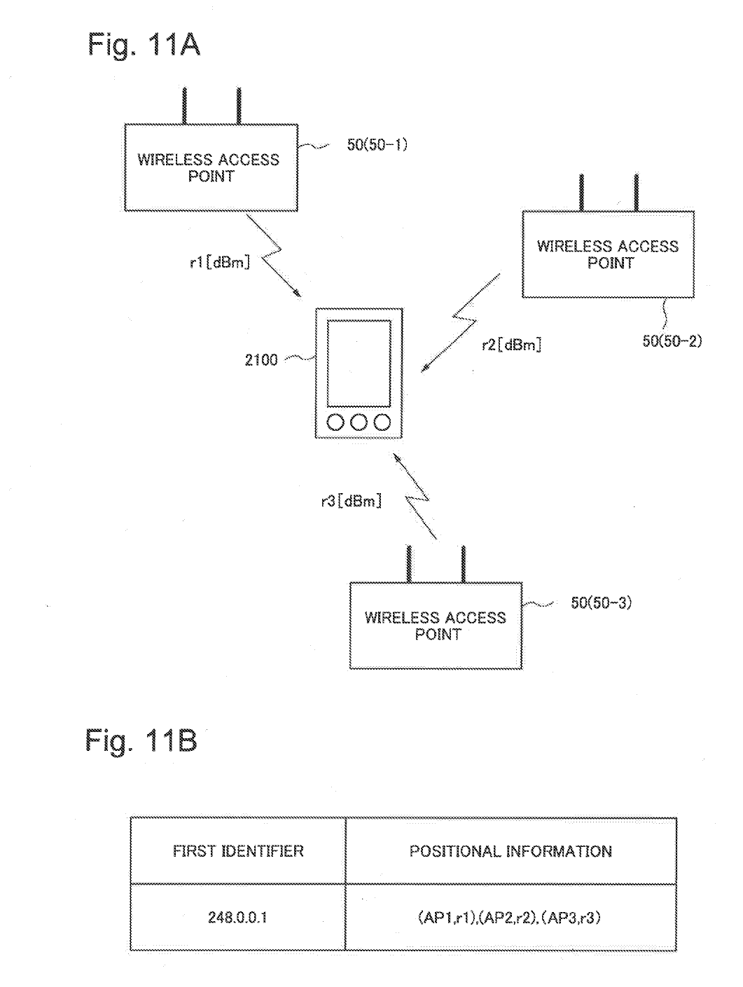

FIGS. 11A and 11B are explanatory diagrams illustrating a technique that uses the intensity of radio wave received from a plurality of wireless access points 50 as the terminal positional information. In FIG. 11A, each intensity of radio wave in which the portable terminal 2100 receives from wireless access points 50 (50-1, 50-2, and 50-3) is denoted as r1, r2, and r3 (in dBm). In such cases, the terminal positional information may be represented as, for example, the information shown in FIG. 11B. The example in FIG. 11B shows that the wireless access points 50-1, 50-2, and 50-3 are given AP1, AP2, and AP3, respectively, as their identification information. The terminal positional information regarding the portable terminal 2100 is composed of combinations, each of which is formed of the information on identifying a wireless access point that emitted the received radio wave and the intensity of radio wave received from the wireless access point. In the example in FIG. 11B, the terminal positional information is associated with the first identifier of the portable terminal 2100.

The imaging device positional information representing the position of the imaging device 2200 is expressed in a way similar to the terminal positional information.

For example, when the imaging device 2200 is installed, the control device 2300 stores into its built-in storing unit the imaging device positional information regarding the imaging device 2200. By the way, the imaging device 2200 may be moved to another place sometime after installed. In view of such movement, the imaging device positional information stored in the storing unit is preferably updated at regular or irregular intervals.

For example, the imaging device positional information is updated with a frequency such as once a day or once a month. The imaging device positional information may be updated manually, or may be updated by the control device 2300 to the new imaging device positional information obtained from the imaging device 2200. Alternatively, the imaging device 2200 may be configured so as to transmit, when moved to a new installation location, the imaging device positional information representing the new installation location to the control device 2300.

The information processing system 2000 of the third example embodiment detects the number of portable terminal 2100 being present within the imaging area 10 by using the positional information regarding the portable terminal 2100. Thus, the generating unit 2310 in the control device 2300 can generate the second identifier of suitable data size that depends on the detected number of portable terminal 2100. Hence, the information processing system 2000 of the third example embodiment provides an effect similar to that provided by the second example embodiment.

### Fourth Example Embodiment

A fourth example embodiment of the present invention will now be described. In description about the fourth example embodiment, identical reference symbols are used for components identical to those of the information processing system according to the first example embodiment, and duplicate descriptions concerning the identical components are omitted.

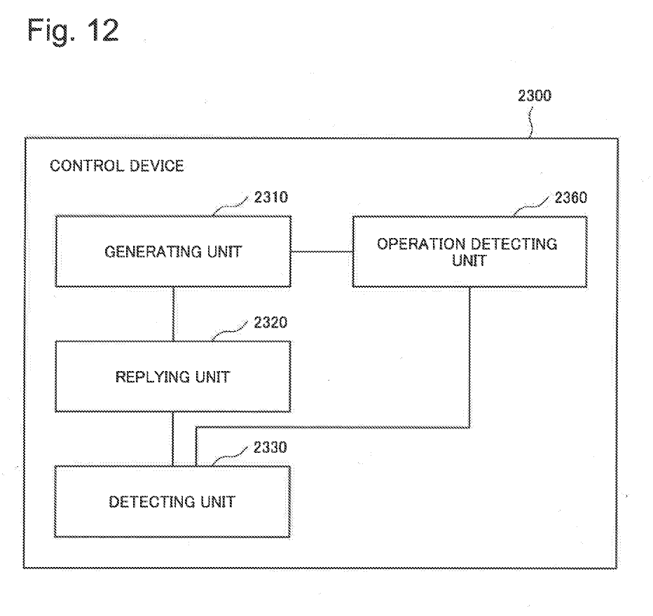

FIG. 12 is a block diagram schematically illustrating a configuration of the control device 2300 forming part of the information processing system 2000 according to the fourth example embodiment. Note that each block depicted in FIG. 12 represents a functional component, not a hardware component.

In the fourth example embodiment, the control device 2300 further includes an operation detecting unit 2360 in addition to the configuration of the first example embodiment. The operation detecting unit 2360 has a function to detect a predetermined user operation from an image captured by the imaging device 2200.

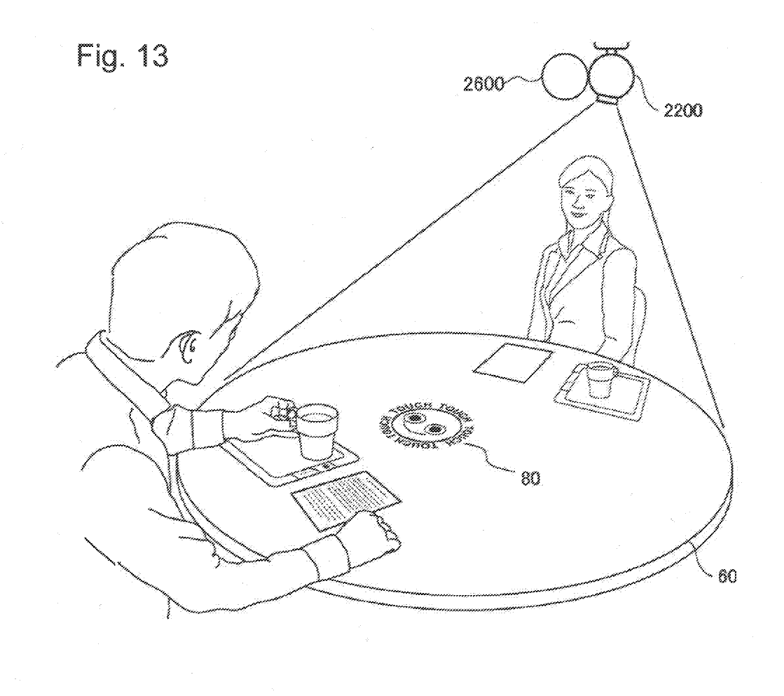

The operation detecting unit 2360 detects a predetermined user operation among a variety of possible user operations that can be detected by the operation detecting unit 2360. For example, the user operation may be a predetermined gesture made by the user. Here are some specific examples. By way of example, the information processing system 2000 includes a projector 2600 as illustrated in FIG. 13. For example, the projector 2600, which is a device to project an image, projects a predetermined image 80 onto a predetermined projection place (i.e., a top face of a table 60 in the example in FIG. 13). The projected image 80 is used for guiding the user to perform an operation (make a gesture) which is to be detected by the operation detecting unit 2360. In other words, the image 80 serves as an input interface through which the user uses the information processing system 2000. In the example in FIG. 13, when the user makes a movement (gesture) of touching the image 80 projected on the top face of the table 60, the operation detecting unit 2360 detects the user operation.

Alternatively, the operation detecting unit 2360 may detect a predetermined operation performed by the user onto a predetermined physical object. For example, a predetermined mark may be made on the top face of a table at which a user will be seated. When the user performs the operation of touching the mark, the operation detecting unit 2360 detects the user operation.

According to the fourth example embodiment, the detecting unit 2330 detects the imaging device 2200 which captured the image from which the operation detecting unit 2360 has detected a predetermined user operation. The detecting unit 2330 detects the second identifier of the portable terminal 2100 based on the image captured by the detected imaging device 2200.

In the information processing system 2000 of the fourth example embodiment, the detecting unit 2330 detects the second identifier of the portable terminal 2100 based on the image captured by the imaging device 2200 that is identified using the result of detection performed by the operation detecting unit 2360. Using the result of detection by the operation detecting unit 2360 in this way allows the detecting unit 2330 to easily identify the image captured by the imaging device 2200 for identifying the second identifier. In particular, with the image serving as the input interface like the image 80 illustrated in FIG. 13, the information processing system 2000 can provide users with an easy-to-understand user operation for the authentication process needed before using the information processing system 2000.

### Fifth Example Embodiment

A fifth example embodiment of the present invention will now be described. In descriptions about the fifth example embodiment, identical reference symbols are used for components identical to those of the information processing system 2000 according to any of the first to fourth example embodiments, and duplicate descriptions concerning the identical components are omitted.

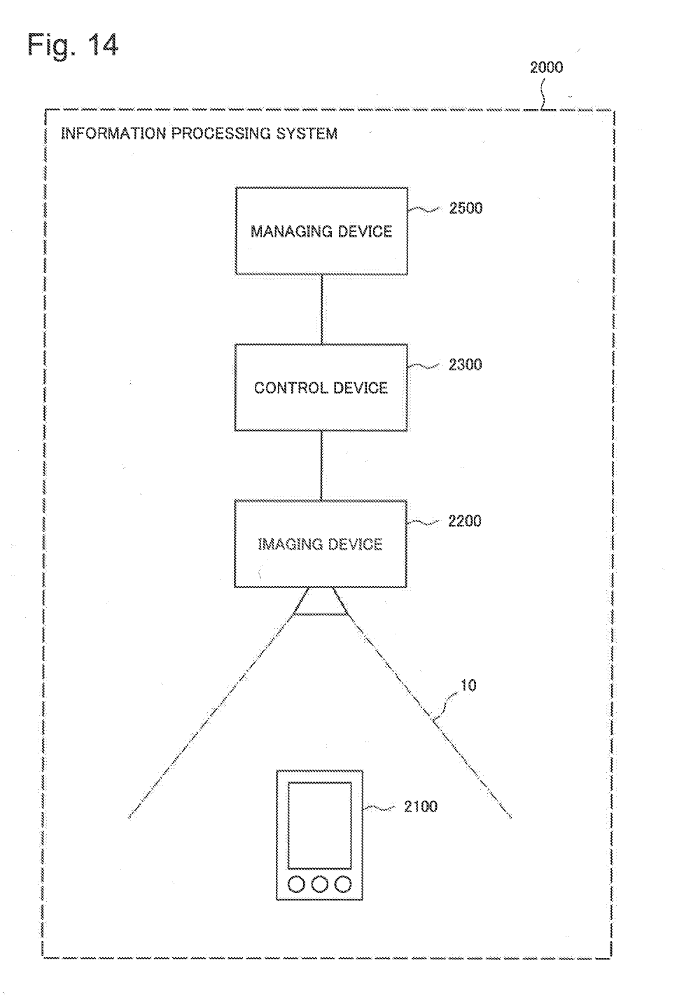

FIG. 14 is a diagram schematically illustrating a configuration of the information processing system 2000 according to the fifth example embodiment. In addition to the configuration according to any of the first to fourth example embodiments, the information processing system 2000 of the fifth example embodiment includes a managing device 2500. The managing device 2500 is a device having a function to determine (manage) whether to provide the content to the portable terminal 2100. In addition to the function to determine whether to provide the content, the managing device 2500 may or may not have a function to provide (transmit) the content to the portable terminal 2100 that has been determined to be provided with the content.

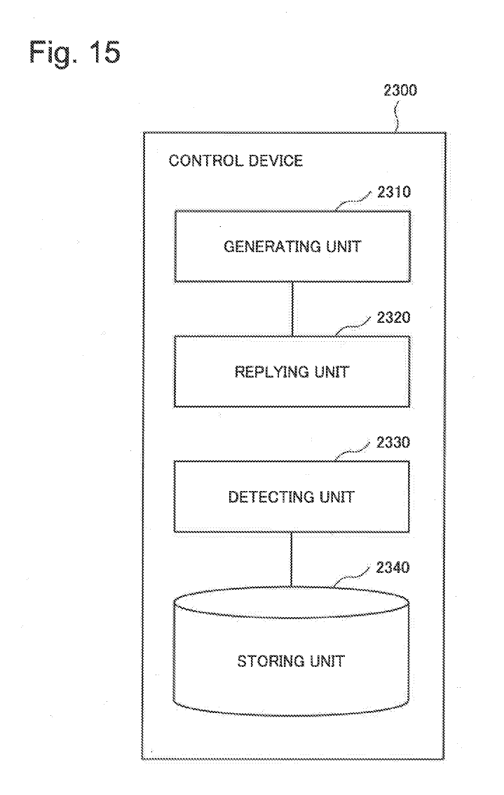

FIG. 15 is a block diagram schematically illustrating a configuration of the control device 2300 according to the fifth example embodiment. Note that each block in FIG. 15 represents a functional component, not a hardware component.

In the fifth example embodiment, the control device 2300 includes a storing unit 2340. The storing unit 2340 stores the first identifier of the portable terminal 2100 corresponding to the second identifier detected by the detecting unit 2330. For example, after generating the second identifier, the generating unit 2310 temporarily stores the generated second identifier associated with the first identifier of the portable terminal 2100 to which the second identifier is to be given. Then, the detecting unit 2330 determines whether it has detected the second identifier based on the image captured by the imaging device 2200, for example, during a monitoring period up to a lapse of a predetermined period after the generation of the second identifier by the generating unit 2310. When the detecting unit 2330 detects the second identifier through the determination, the detecting unit 2330 obtains the second identifier and the first identifier associated with the second identifier from the generating unit 2310, and writes the first and second identifiers being associated with each other into the storing unit 2340. In the fifth example embodiment, the first identifier represents information about the address of the portable terminal 2100.

The managing device 2500 determines that the content can be provided to the portable terminal 2100 as long as its first identifier is stored in the storing unit 2340. The information processing system 2000 provides the portable terminal 2100 with predetermined content, which may be, for example, music, movies, games, or electronic books.

The information processing system 2000 of the fifth example embodiment has a function to provide the content to portable terminal 2100. To authenticate the portable terminal 2100 to which the content may be provided, the fifth example embodiment employs the authentication method provided by the information processing system 2000 according to any of the first to fourth example embodiments. Since the authentication methods described in the first to fourth example embodiments achieve authentication without taking time and effort of the user, the information processing system 2000 of the fifth example embodiment can enhance the convenience. Furthermore, the information processing system 2000 has the ability to properly manage the content to be provided.

Each individual example embodiment described above provides a method of providing the content to the portable terminal 2100 based on the second identifier being visually presented. Such method is especially effective in the cases where the content is desired to be provided (lent) to users located in a place of a limited size such as a coffee shop or hair salon. For example, magazines and the like are lent to customers in a hair or beauty salon. In some places like comic cafes, books, games, movies, and other similar content may be lent. The information processing system 2000 of the fifth example embodiment makes it easy to limit an area where the provided (lent) content can be used.

### Sixth Example Embodiment

A sixth example embodiment of the present invention will now be described. In descriptions about the sixth example embodiment, identical reference symbols are used for components identical to those of the information processing system according to each of the aforementioned example embodiments, and duplicate descriptions concerning the identical components are omitted.

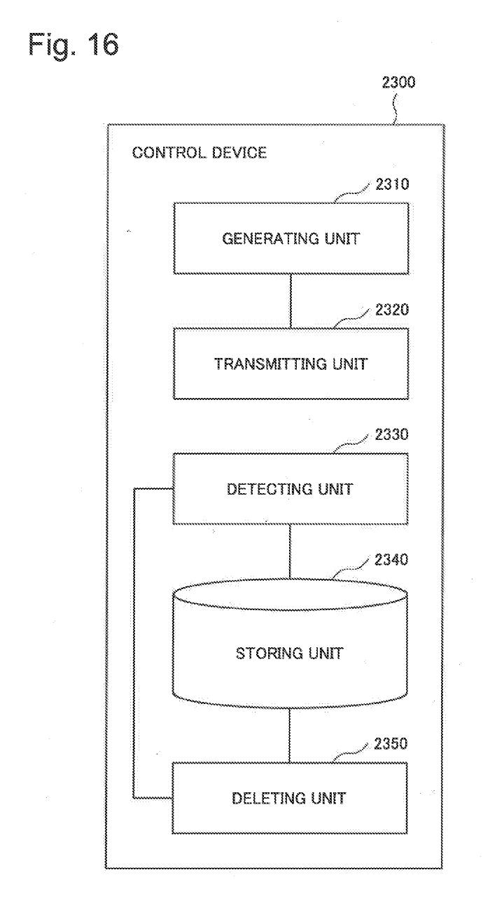

FIG. 16 is a block diagram schematically illustrating a configuration of the control device 2300 according to the sixth example embodiment. Note that each block in FIG. 16 represents a functional component, not a hardware component.

In addition to the configuration according to the fifth example embodiment, the information processing system 2000 of the sixth example embodiment includes a deleting unit 2350 in the control device 2300. The deleting unit 2350 has a function to delete the first identifier stored in the storing unit 2340. In other words, the deleting unit 2350 has a function to manage the first identifier stored in the storing unit 2340 in the way described below.

For example, the deleting unit 2350 determines whether the detecting unit 2330 can detect again the second identifier of the portable terminal 2100 whose first identifier is stored in the storing unit 2340. Specifically, the detecting unit 2330 determines whether it can detect the second identifier again at predetermined intervals with respect to the portable terminal 2100 whose first identifier is stored in the storing unit 2340. When the detecting unit 2330 cannot detect the second identifier, the deleting unit 2350 deletes the second identifier and the first identifier associated with the second identifier from the storing unit 2340. Thus, once the first identifier is deleted from the storing unit 2340, the information processing system 2000 is prevented from providing the content to the portable terminal 2100 having the first identifier that has been deleted.

In the case where the first identifier of the portable terminal 2100 may be changed, it is preferable to acquire the terminal information from the portable terminal 2100 to obtain the first identifier again.

Repeating the process of detecting the second identifier of the portable terminal 2100 in this way allows the information processing system 2000 to continue accurate detection of whether the portable terminal 2100 is present within the imaging area 10 of the imaging device 2200. In other words, the information processing system 2000 can keep monitoring to find whether the portable terminal 2100 is allowed to use the information processing system 2000.

In another example, the deleting unit 2350 may delete the pair of first and second identifiers stored in the storing unit 2340 in the way described below. In this example, the deleting unit 2350 deletes the first identifier of the portable terminal 2100 when the positional relation between the portable terminal 2100 and the imaging device 2200 which has captured the image of the second identifier of the portable terminal 2100 no longer meets a predetermined condition. In this example, the storing unit 2340 stores the first and second identifiers of the portable terminal 2100 along with their associated identifier (hereinafter called imaging device identifier) for identifying the imaging device 2200 that has captured the image of the second identifier. As with the first identifier of the portable terminal 2100, the imaging device identifier is represented by an address of the imaging device 2200 such as an IP address, MAC address, or UUID.

For example, the deleting unit 2350 obtains the first identifier and the imaging device identifier which are associated each other and are stored in the storing unit 2340. Then, the deleting unit 2350 obtains the terminal positional information from the portable terminal 2100 having the obtained first identifier. The portable terminal 2100 may be configured to send the terminal positional information in response to an instruction given by the deleting unit 2350, or may be configured to send the terminal positional information at regular or irregular intervals. In addition, the deleting unit 2350 obtains the imaging device positional information regarding the imaging device 2200 that has the obtained imaging device identifier.

The deleting unit 2350 uses the terminal positional information and the imaging device positional information to determine whether to delete the first identifier. For example, the deleting unit 2350 calculates the distance between the portable terminal 2100 and the imaging device 2200 using the terminal positional information and the imaging device positional information. The distance calculated here may be a physical distance, or may be a logical distance in a logical coordinate space based on a technology such as GPS. The logical coordinate space refers to a space where a point is represented by logical coordinates which are virtually defined by a computer.

If the calculated distance is greater than a distance specified in advance, the deleting unit 2350 deletes the combination of the first identifier, the second identifier and the imaging device identifier corresponding to the portable terminal 2100 and the imaging device 2200 being away from each other by the calculated distance.

Alternatively, in the case where the imaging device 2200 is connected to the wireless access point 2400 as in the second example embodiment, the deleting unit 2350 may make the determination as described below. For example, the deleting unit 2350 determines whether the portable device 2100 is connected to the wireless access point 2400 to which the imaging device 2200 is connected (in other words, whether the portable terminal 2100 is using the wireless access point 2400). If the deleting unit 2350 determines that the portable terminal 2100 is not using the wireless access point 2400, the deleting unit 2350 deletes the combination of the first and second identifiers of the portable terminal 2100 from the storing unit 2340.

In the above-described example, the deleting unit 2350 deletes information stored in the storing unit 2340 based on the positional relation between the portable terminal 2100 and the imaging device 2200 depending on whether the portable terminal 2100 is connected to the wireless access point 2400. Compared with the case of deleting information based on the second identifier, this example can extend an area where services of the information processing system 2000 are available. By way of example, suppose that the user's portable terminal 2100 is authenticated by the information processing system 2000, and then the user moves around in the shop carrying the portable terminal 2100. Even if the portable terminal 2100 is out of the imaging area 10 of the imaging device 2200 as a result of the movement, the content would still be provided to the portable terminal 2100 as long as the portable terminal 2100 is within the area where it can be connected to the wireless access point 2400. Thus, convenience of the information processing system 2000 to users of the content is enhanced.

Alternatively, the deleting unit 2350 may delete the combination of the first identifier and the second identifier when an elapsed time since these identifiers were stored in the storing unit 2340 exceeds a predetermined time Ts. For this purpose, when storing the first identifier and other information into the storing unit 2340, the detecting unit 2330 may, for example, associate information representing a storage time with the first identifier. Or, when storing the first identifier into the storing unit 2340, the detecting unit 2330 may set a timer so as to perform the process of deleting the first identifier after the predetermined time Ts has passed.

As seen above, in the case where the first identifier is deleted after the predetermined time Ts has passed, the configuration involved in the process of determining whether the deleting unit 2350 should delete information in the storing unit 2340 is made simple. As a result, the deleting unit 2350 can reduce the time and calculation amount needed for making determination about the deletion, and the deleting unit 2350 can be put to practical use easily.

If a plurality of imaging devices 2200 are installed, each of the imaging devices 2200 capturing image of the second identifier may have its own predetermined time Ts. Alternatively, the predetermined time Ts to be used for determining the deletion may be set for each of groups into which the plurality of imaging devices 2200 are divided. For example, the predetermined time Ts may be set to 10 minutes for the first identifier of the portable terminal 2100 whose second identifier is imaged by the imaging device 2200 installed in a shop A. On the other hand, the predetermined time Ts may be set to 30 minutes for a first identifier of the portable terminal 2100 whose second identifier is imaged by the imaging device 2200 installed in another shop B.

Having such different predetermined times Ts gives advantages described below. First, the desirable length of a customer's stay in s shop may be different depending on factors such as the type of the shop, site location, and time zone. For example, it may be permissible for customers to stay long in a suburban coffee shop, while it may be desirable that customers stay for a shorter time in an urban coffee shop. In another example, it may be desired to make a shop look like a popular shop by shortening customers' stay during lunch for a higher turnover rate, while prolonging service provision to customers during other time zones for higher customer satisfaction.

In such cases, it is preferable to set a service available time (i.e., the predetermined time Ts) so that, for example, customers can use the content for a longer time in a suburban coffee shop, while customer can use the content for a shorter time in an urban coffee shop.

The deleting unit 2350 may further have a function to extend the predetermined time Ts which is used for determining whether to delete information in the storing unit 2340. For example, the deleting unit 2350 may, for example, at any time before a predetermined time Ts has passed, perform the process of re-detecting the second identifier of the portable terminal 2100 for making determination about the deletion, or may perform the process of determining the positional relation between the portable terminal 2100 and the imaging device 2200. If the second identifier is re-detected or it is determined that the positional relation between the portable terminal 2100 and the imaging device 2200 meets a predetermined condition, the deleting unit 2350 extends the predetermined time Ts. The predetermined time may be set to any suitable time.

The deleting unit 2350 performs the aforementioned deleting process at regular or irregular intervals. If the deleting process is performed regularly, the intervals may be the same or different among first identifiers.

In addition, the deleting unit 2350 may carry out both the determination using re-detection of the second identifier and the determination based on the positional relation between the portable terminal 2100 and the imaging device 2200 to determine whether to delete the first identifier and other information in view of these determinations. For example, the deleting unit 2350 carries out the determination based on the positional relation between the portable terminal 2100 and the imaging device 2200 at shorter time intervals than the time intervals at which the deleting unit 2350 carries out the determination using re-detection of the second identifier. Then, if the positional relation between the portable terminal 2100 and the imaging device 2200 meets the predetermined condition, the deleting unit 2350 extends the time intervals at which the deleting unit 2350 carries out the determination using re-detection of the second identifier. Finally, the deleting unit 2350 deletes from the storing unit 2340 the first identifier and other information that have been determined to be deleted as a result of the determination carried out based on re-detection of the second identifier.

The information processing system 2000 according to the sixth example embodiment has the function to manage information about first identifiers stored in the storing unit 2340. The first identifier stored in the storing unit 2340 is the information representing the address of the portable terminal 2100 to which the information processing system 2000 provides the content. Thus, properly managing the first identifier in the storing unit 2340 allows the information processing system 2000 to provide the content properly.

In general, compared with lending physical magazines or other materials to users, a method used for providing (lending) digital content to users' portable terminals has more difficulty in collecting the content from users after lending. In contrast, the information processing system 2000 of the sixth example embodiment can easily stop providing the content to the portable terminal 2100 owing to the deleting process described above. With the deleting process, which is equivalent to collecting the content that has been lent to users, the information processing system 2000 of the sixth example embodiment easily achieves collecting the content.

### Seventh Example Embodiment

A seventh example embodiment of the present invention will now be described. In descriptions about the seventh example embodiment, identical reference symbols are used for components identical to those of the information processing system 2000 according to any of the first to sixth example embodiments, and duplicate descriptions concerning the identical components are omitted.

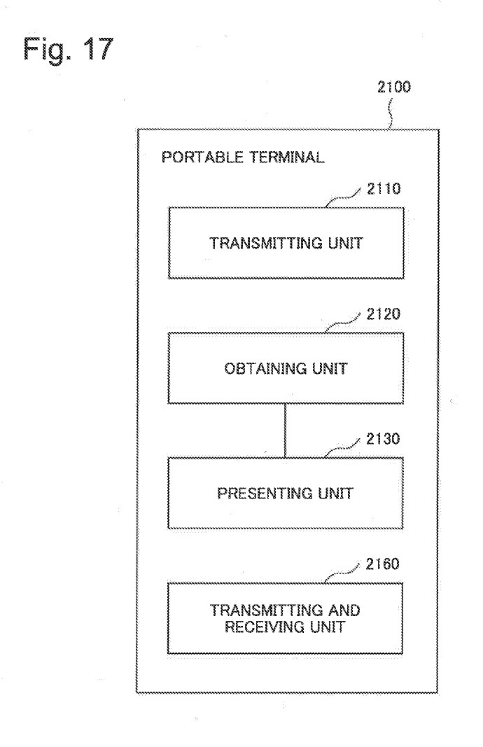

FIG. 17 is a block diagram schematically illustrating a configuration of the portable terminal 2100 according to the seventh example embodiment. Note that each block in FIG. 17 represents a functional component, not a hardware component.

In addition to the configuration according to the fifth or sixth example embodiment, the information processing system 2000 of the seventh example embodiment includes a transmitting and receiving unit 2160 in the portable terminal 2100. The configuration except the transmitting and receiving unit 2160 is similar to that of the fifth or sixth example embodiment, and thus descriptions about the similar configuration are omitted.

The transmitting and receiving unit 2160 includes a configuration that allows the content to be transmitted/received between portable terminals 2100 to which the information processing system 2000 provides the content.

By way of example, it is assumed here that the portable terminal 2100 to which the information processing system 2000 provides the content has already obtained the first identifier (address information) of another portable terminal, to which the portable terminal 2100 wants to provide the content. Then, the transmitting and receiving unit 2160 in the portable terminal 2100 sends to the control device 2300 a notice requesting for permission to transmit the content (hereinafter denoted as request notice). The request notice includes the first identifier of each portable terminal 2100-1 which is desired to transmit/receive the content.

Upon receipt of the request notice, the control device 2300 determines whether the two first identifiers included in the request notice are stored in the storing unit 2340. If both of the first identifiers are stored in the storing unit 2340, the control device 2300 returns a notice permitting transmission of the content (hereinafter denoted as permission notice) to the portable terminal 2100 which has sent the request notice. On the other hand, if any of the first identifiers is not stored in the storing unit 2340, the control device 2300 replies a notice forbidding transmission of the content (hereinafter denoted as forbidding notice) to the portable terminal 2100 which has sent the request notice.

When the portable terminal 2100 receives the permission notice, the transmitting and receiving unit 2160 transmits the content to the other portable terminal 2100 which is the destination of the permitted content. On the other hand, when the portable terminal 2100 receives the forbidding notice, the transmitting and receiving unit 2160 does not transmit the content to the other portable terminal 2100.

Alternatively, instead of the transmitting and receiving unit 2160 in the portable terminal 2100 which is to transmit the content, the transmitting and receiving unit 2160 in the other portable terminal 2100 which desires to receive the content may be configured to send a request notice in a similar manner. In this case, when the portable terminal 2100 obtains the permission notice, the transmitting and receiving unit 2160 sends a request for provision of the content to the other portable terminal 2100 which is the source of the content. When the portable terminal 2100 receives the request, the transmitting and receiving unit 2160 transmits the content to the other portable terminal 2100 in response to the request.

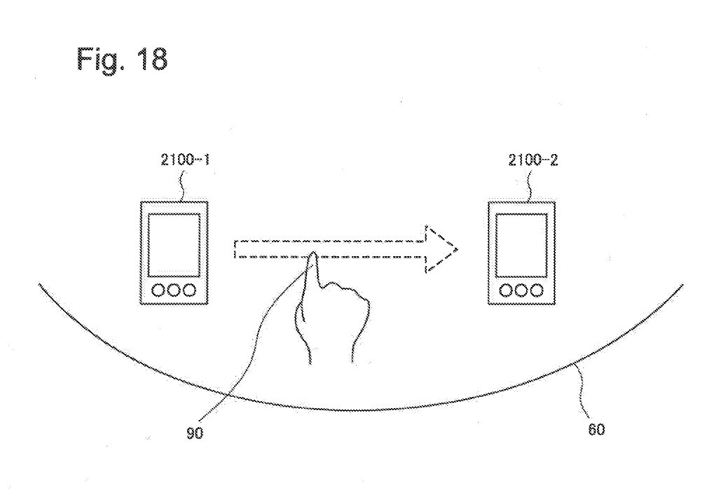

Alternatively, the transmitting and receiving unit 2160 may have the function described below. It is assumed here that the control device 2300 includes the operation detecting unit 2360 as described in the fourth example embodiment. The user performs a predetermined user operation to instruct the system to transmit the content. For example, as illustrated in FIG. 18, the user makes a movement on the two portable terminals 2100-1 and 2100-2 placed on the table 60 such as moving a finger from one to the other. Upon detection of the operation, the operation detecting unit 2360 determines whether to permit transmission of the content.

To determine whether to permit transmission of the content, the control device 2300 recognizes the presence of portable terminals 2100-1 and 2100-2. It is assumed here that both the portable terminals 2100-1 and 2100-2 are still presenting their respective second identifiers after their first identifiers are stored in the storing unit 2340. When the operation detecting unit 2360 detects the operation indicating transmission of content, the detecting unit 2330 detects the second identifier given to the portable terminal 2100-1 located on the source side (i.e., the starting point of the finger operation) of the content. In addition, the detecting unit 2330 detects the second identifier given to the portable terminal 2100-2 located on the destination side (i.e., the end point of the finger operation) of the content. Then, the control device 2300 determines whether the first identifiers respectively associated with the detected individual second identifiers are stored in the storing unit 2340. If both of the first identifiers are stored in the storing unit 2340, the control device 2300 sends the permission notice, as described above, to the portable terminal 2100-1 or 2100-2. On the other hand, if any of the first identifiers is not stored in the storing unit 2340, the control device 2300 sends the forbidding notice, as described above, to the portable terminal 2100-1 or 2100-2.

The transmitting and receiving unit 2160 operates as described above, in response to the permission or forbidding notice received from the control device 2300.

The portable terminals 2100 permitted may communicate with each other using any of a variety of possible communication techniques. Examples of the techniques for communications between portable terminals 2100 may include 3G and LTE, or wireless LAN such as Wi-Fi®. The wireless communications between portable terminals 2100 may be made via a wireless access point or directly without such access point.

The information processing system 2000 of the seventh example embodiment allows the portable terminals 2100 whose first identifiers are stored in the storing unit 2340 to transmit/receive the content to/from each other. By the way, it takes a longer time to acquire the content from a content provider such as a server than from a neighbor portable terminal 2100. According to the seventh example embodiment, the portable terminal 2100 having acquired the content from the content provider such as a server can provide the content to another nearby portable terminal 2100 which is enabled to use the information processing system 2000. In other words, once enabled to use the information processing system 2000, the portable terminal 2100 is provided with the content by another nearby portable terminal 2100 which has acquired the content. As a result, the portable terminal 2100 that is provided with the content by the other portable terminal 2100 can acquire the content in a shorter time. The information processing system 2000 of the seventh example embodiment is especially effective in, for example, the cases where the content is shared with the user's friends or content of large data size (e.g., movies or games) is handled.

### Eighth Example Embodiment

An eighth example embodiment of the present invention will now be described. In descriptions about the eighth example embodiment, identical reference symbols are used for components identical to those of the information processing system according to any of the first to seventh example embodiments, and duplicate descriptions concerning the identical components are omitted.

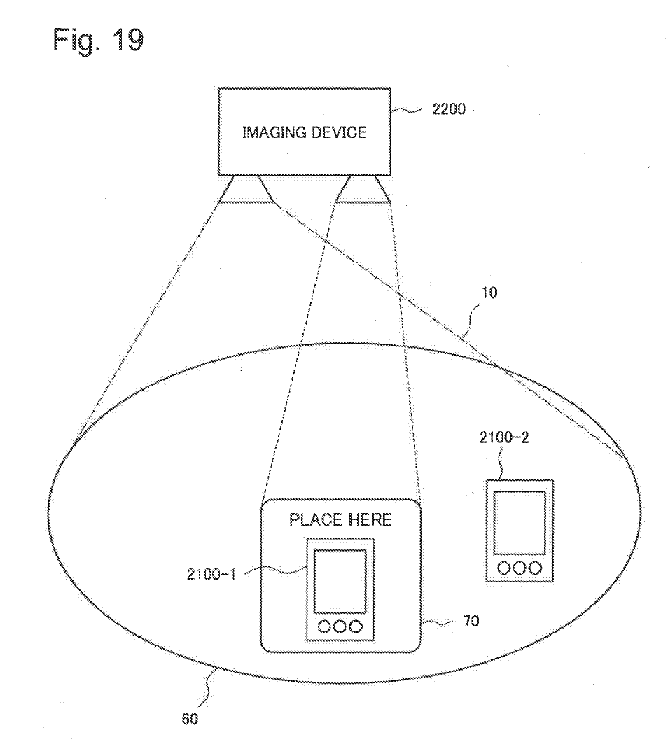

In addition to the configuration according to any of the first to seventh example embodiments, the imaging device 2200 in the information processing system 2000 of the eighth example embodiment has a function to serve as a projection device that projects a projected image 70 as illustrated in FIG. 19 onto an imaging area 10. According to the eighth example embodiment, the detecting unit 2330 in the control device 2300 detects the second identifier from an area showing a projected image in the image captured by the imaging device 2200.

In the example in FIG. 19, the imaging area 10 covers the whole top face of a table 60, and the imaging device 2200 projects a projected image 70 onto the top face of the table 60.

The detecting unit 2330 recognizes the area showing the projected image 70 in the captured image as the area for detecting the second identifier. Thus, when the portable terminal 2100-1 placed in the projected image 70 visually presents the second identifier, the detecting unit 2330 detects the second identifier. On the other hand, when the portable terminal 2100-2 placed out of the projected image 70 visually presents the second identifier, the detecting unit 2330 does not detect the second identifier.

Based on the area showing the projected image 70 in the captured image, the detecting unit 2330 detects the second identifier in the way described below. For example, the detecting unit 2330 obtains the image data containing the projected image 70, and detects an area identical or similar to the obtained image data from the image captured by the imaging device 2200. The detecting unit 2330 then detects the second identifier through image processing on the detected area. The detecting unit 2330 may obtain the image data containing the projected image 70 from the imaging device 2200, or from the control device 2300 which is given the image data of the projected image 70 in advance.

In another example, the detecting unit 2330 may identify the area showing the projected image 70 in the captured image based on the relation between the imaging area 10 of the imaging device 2200 and the direction in which the projected image 70 is projected by the imaging device 2200. The detecting unit 2330 then detects the second identifier through image processing on the detected area. In this case, the detecting unit 2330 obtains from the imaging device 2200 the information representing the direction in which the projected image 70 is projected as well as the information representing the imaging area 10.

The imaging device 2200 according to the eighth example embodiment includes, for example, a visible light projection device or an infrared light projection device. The imaging device 2200 projects the image by using such device to project a light representing predetermined patterns, characters, or the like.

The configuration of the information processing system 2000 of the eighth example embodiment except the above-described difference is identical to that of any of the first to seventh example embodiments, and thus descriptions about the identical configuration are omitted. In the case where the control device 2300 of the eighth example embodiment includes the operation detecting unit 2360 described in the fourth example embodiment, the operation detecting unit 2360 may detect, for example, the user operation of placing the portable terminal 2100 on the projected image 70. Then, the detecting unit 2330 detects the second identifier using the image that is captured after the operation detecting unit 2360 detects the operation.

The detecting unit 2330 in the information processing system 2000 according to the eighth example embodiment analyzes a partial area of the image captured by the imaging device 2200. That is, the eighth example embodiment reduces the time and calculation amount for the detecting unit 2330 to analyze the captured image.

In addition, the eighth example embodiment makes it possible to project a message to users by using the projected image 70. This enables the information processing system 2000 to present how to use the system 2000 to users. As a result, convenience of the information processing system 2000 can be enhanced.

The present invention has been explained above with the first to eighth embodiments as exemplary examples. However, the present invention is not limited to the first to eighth example embodiments. In other words, various aspects of the present invention that could be understood by those skilled in the art may be applied within the scope of the present invention.

The present application claims priority based on Japanese Patent Application No. 2014-113004 filed on May 30, 2014, the entire disclosure of which is incorporated herein.

The whole or part of the first to eighth example embodiments can be described as, but is not limited to, the following supplementary notes.

### (Supplementary Note 1)

In an information processing system including a portable terminal, an imaging device and a control device,

the portable terminal includes:
a transmitting unit that transmits terminal information including a first identifier of the portable terminal;
an obtaining unit that obtains a second identifier of the portable terminal different from the first identifier; and
a presenting unit that visually presents the second identifier,

and the control device includes:
a generating unit that obtains the terminal information and generates the second identifier of the portable terminal corresponding to the terminal information by using the terminal information;
a transmitting unit that transmits the second identifier of the portable terminal to the portable terminal; and
a detecting unit that obtains an image captured by the imaging device and detects the second identifier presented visually by the portable terminal based on the image obtained.

### (Supplementary Note 2)

The information processing system according to Supplementary Note 1 includes a wireless access point to which the portable terminal can be connected by wireless communication,

the generating unit
identifies the wireless access point to which the portable terminal corresponding to the terminal information obtained is connected by wireless communication, and
generates the second identifier of a size corresponding to the number of device connected to the identified wireless access point by wireless communication,

and the detecting unit detects the second identifier by using the image captured by the imaging device which is communicatively connected to the wireless access point identified by the generating unit.

### (Supplementary Note 3)

In the information processing system according to Supplementary Note 1, the terminal information regarding the portable terminal includes terminal positional information regarding a position of the portable terminal,

the generating unit
determines, by using positional information indicated by the terminal information as well as by using imaging device positional information regarding a position of an imaging device, a candidate imaging device whose imaging area includes the portable terminal corresponding to the terminal information,
identifies the portable terminal(s) located near the imaging device determined to be a candidate, and
generates a second identifier of a size corresponding to the number of the identified portable terminals,

the detecting unit detects the second identifier using the image captured by the imaging device determined to be the candidate by the generating unit.

### (Supplementary Note 4)

In the information processing system according to Supplementary Note 1, the control device includes

an operation detecting unit that detects a predetermined user operation from the image captured by the imaging device,

the detecting unit detects the second identifier from the image captured by the imaging device that captured the image from which the predetermined user operation has been detected.

### (Supplementary Note 5)

In the information processing system according to any one of Supplementary Notes 1 to 4, the control device includes

a storing unit that stores the first identifier of the portable terminal whose second identifier has been detected,

the information processing system includes

a managing device that determines that the portable terminal whose first identifier is stored in the storing unit is to be provided with content.

### (Supplementary Note 6)

In the information processing system according to Supplementary Note 5, the control device includes

a deleting unit that executes again detection of the second identifier of the portable terminal whose first identifier is stored in the storing unit, and, if the second identifier is not detected, deletes the first identifier of the portable terminal from the storing unit.

### (Supplementary Note 7)

In the information processing system according to Supplementary Note 5, the control device includes

a deleting unit that deletes the first identifier from the storing unit when a predetermined time has passed since the first identifier was stored in the storing unit.

### (Supplementary Note 8)

In the information processing system according to Supplementary Note 5, the storing unit stores an imaging device identifier which is associated with the first identifier regarding the imaging device that has detected the second identifier of the portable terminal having the first identifier,

the control device includes
a deleting unit that deletes, with respect to a combination of the first identifier and the imaging device identifier that are stored in the storing unit, when a positional relation between the portable terminal having the first identifier and the imaging device having the imaging device identifier no longer meets a predetermined condition, the combination of the first identifier and the imaging device identifier from the storing unit.

### (Supplementary Note 9)

The information processing system according to any one of Supplementary Notes 5 to 8 includes the portable terminal denoted as first portable terminal and the portable terminal denoted as second portable terminal,

the portable terminal includes
a transmitting and receiving unit that transmits and receives the content to and from the other portable terminal,

the content can be transmitted and received between the first portable terminal and the second portable terminal when both the first identifier of the first portable terminal and the first identifier of the second portable terminal are stored in the storing unit.

### (Supplementary Note 10)

In the information processing system according to any one of Supplementary Notes 1 to 9, the presenting unit in the portable terminal presents a character string or an image representing the second identifier on a display screen included in the portable terminal.

### (Supplementary Note 11)

In the information processing system according to any one of Supplementary Notes 1 to 9, the presenting unit in the portable terminal causes a light source included in the portable terminal to blink in a pattern that is based on the second identifier.

### (Supplementary Note 12)

In the information processing system according to any one of Supplementary Notes 1 to 11, the imaging device projects a projected image within the imaging area,

the detecting unit detects the second identifier from an area that is included in the image captured by the imaging device and that shows the projected image.

### (Supplementary Note 13)

The portable terminal is included in the information processing system according to any one of Supplementary Notes 1 to 12.

### (Supplementary Note 14)

The control device is included in the information processing system according to any one of Supplementary Notes 1 to 12.

### (Supplementary Note 15)

In a control method executed by an information processing system that includes a portable terminal, an imaging device, and a control device, the method includes:

a terminal information transmitting step of transmitting terminal information including a first identifier of the portable terminal, the terminal information transmitting step being executed by the portable terminal;

a second identifier generating step of obtaining the terminal information and, by using the terminal information, generating the second identifier of the portable terminal corresponding to the terminal information, the second identifier generating step being executed by the control device;

a second identifier transmitting step of transmitting the second identifier of the portable terminal to the portable terminal, the second identifier transmitting step being executed by the control device;

a second identifier obtaining step of obtaining the second identifier of the portable terminal different from the first identifier, the second identifier obtaining step being executed by the portable terminal;

a presenting step of visually presenting the second identifier, the presenting step being executed by the portable terminal; and

a detecting step of detecting, from the image captured by the imaging device, the second identifier presented by the portable terminal, the detecting step being executed by the control device.

### (Supplementary Note 16)

In the control method according to Supplementary Note 15,

the information processing system includes a wireless access point to which the portable terminal can be connected by wireless communication,

the second identifier generating step includes:
identifying a wireless access point to which the portable terminal corresponding to the obtained terminal information is connected by wireless communication; and
generating a second identifier of a size corresponding to the number of devices connected to the identified wireless access point by wireless communication,

the detecting step includes
detecting the second identifier by using the image captured by the imaging device that is communicatively connected to the wireless access point identified by the second identifier generating step.

### (Supplementary Note 17)

In the control method according to Supplementary Note 15,

the terminal information regarding the portable terminal includes terminal positional information regarding a position of the portable terminal,

the second identifier generating step includes:
determining, by using positional information indicated by the terminal information as well as by using imaging device positional information regarding a position of the imaging device, a candidate for the imaging device whose imaging area includes the portable terminal corresponding to the terminal information;
identifying the portable terminal(s) located near the imaging device determined to be the candidate; and
generating the second identifier of a size corresponding to the number of the identified portable terminals,

and the detecting step includes
detecting the second identifier using the image captured by the imaging device determined to be the candidate by the second identifier generating step.

### (Supplementary Note 18)

In the control method according to Supplementary Note 15, includes:

an operation detecting step of detecting a predetermined user operation from the image captured by the image device, the operation detecting step executed by the control device,

the detecting step includes
detecting the second identifier from the image captured by the imaging device that captured the image from which the predetermined user operation has been detected.

### (Supplementary Note 19)

In the control method according to any one of Supplementary Notes 15 to 18, the control device includes a storing unit that stores the first identifier of the portable terminal whose second identifier has been detected,

the information processing system includes

a managing device that determines that the portable terminal whose first identifier is stored in a detected terminal information storing step is to be provided with content.

### (Supplementary Note 20)

The control method according to Supplementary Note 19 includes

deleting step of re-executing detection of the second identifier of the portable terminal whose first identifier is stored in the storing unit, and, if the second identifier is not detected, deleting the first identifier of the portable terminal from the storing unit, the deleting step executed by the control device.

### (Supplementary Note 21)

The control method according to Supplementary Note 19 includes

a deleting step of deleting the first identifier from the storing unit when a predetermined time has passed since the first identifier was stored in the detected terminal information storing step, the deleting step executed by the control device.

### (Supplementary Note 22)

In the control method according to Supplementary Note 19, the storing unit stores an imaging device identifier, which is associated with the first identifier, of the imaging device that has detected the second identifier of the portable terminal having the first identifier,

the control device includes
a deleting step of deleting, with respect to a combination of the first identifier and the imaging device identifier that are stored in the storing unit, when a positional relation between the portable terminal having the first identifier and the imaging device having the imaging device identifier no longer meets a predetermined condition, the combination of the first identifier and the imaging device identifier from the detected terminal information storing step.

### (Supplementary Note 23)

In the control method according to any one of Supplementary Notes 19 to 22, the information processing system includes the portable terminal denoted as first portable terminal and the portable terminal denoted as second portable terminal,

the control method includes
a terminal-to-terminal communicating step of transmitting and receiving the content to and from the other portable terminal, the terminal-to-terminal communicating step executed by the portable terminal,

the content can be transmitted and received between the first portable terminal and the second portable terminal when both the first identifier of the first portable terminal and the first identifier of the second portable terminal are stored in the storing unit.

### (Supplementary Note 24)

In the control method according to any one of Supplementary Notes 19 to 23, the presenting step executed by the portable terminal includes presenting a character string or an image representing the second identifier on a display screen included in the portable terminal.

### (Supplementary Note 25)

In the control method according to any one of Supplementary Notes 19 to 23, the presenting step executed by the portable terminal includes causing a light source included in the portable terminal to blink in a pattern that is based on the second identifier.

### (Supplementary Note 26)

In the control method according to any one of Supplementary Notes 19 to 25, the imaging device projects a projected image within an imaging area,

the detecting step includes
detecting the second identifier from the area that is included in the image captured by the imaging device and that shows the projected image.

### (Supplementary Note 27)

A program causes a computer to operate as a portable terminal in the information processing system according to any one of Supplementary Notes 1 to 12.

### (Supplementary Note 28)

A program causes a computer to operate as a control device in the information processing system according to any one of Supplementary Notes 1 to 12.

### REFERENCE SIGNS LIST

10 Imaging area
70, 80 Projected image
1140 Display screen
2000 Information processing system
2100 Portable terminal
2120 Obtaining unit
2130 Presenting unit
2160 Receiving unit
2200 Imaging device
2300 Control device
2310 Generating unit
2320 Transmitting unit
2330 Detecting unit
2350 Deleting unit
2360 Operation detecting unit
2400 Wireless access point
2500 Managing device

1. An information processing system comprising:
a portable terminal that includes: a transmitting unit that transmits terminal information including a first identifier which is identification information; an obtaining unit that obtains a second identifier different from the first identifier; and a presenting unit that presents visually the second identifier;
an imaging device that captures an image of a predetermined imaging area; and
a control device that includes: a generating unit that generates the second identifier to identify the portable terminal which has transmitted the terminal information using the terminal information transmitted by the portable terminal; a replying unit that replays the second identifier generated by the generating unit to the portable terminal which has transmitted the terminal information; and a detecting unit that authenticates the portable terminal when detecting that the second identifier is visually presented by the portable terminal based on the image captured by the imaging device.

2. The information processing system according to claim 1, further comprising:
a wireless access point that can be connected to the portable terminal by wireless communication, the portable terminal being in communication connection with the imaging device and being in a predetermined communication area that includes the imaging area of the image device,
wherein the generating unit in the control device generates the second identifier of a data size depending on a number of the portable terminal connected to the wireless access point.

3. The information processing system according to claim 2, including a plurality of the imaging devices and a plurality of the wireless access points,
wherein the generating unit in the control device identifies the wireless access point to which the portable terminal which has transmitted the terminal information obtained by the obtaining unit, is connected by wireless communication, and generates the second identifier of the data size depending on the number of the portable terminal connected to the identified wireless access point,
and wherein the detecting unit in the control device authenticates the portable terminal when detecting that the second identifier is presented visually by the portable terminal using the image captured by the imaging device that is connected to the wireless access point identified by the generating unit.

4. The information processing system according to claim 1, including a plurality of the imaging devices,
wherein the terminal information includes terminal positional information that represents a position of the portable terminal,
wherein the generating unit in the control device chooses a candidate of the imaging device being expected to capture the image of the portable terminal having transmitted the terminal information using the terminal positional information included in the terminal information and imaging device positional information that represents a position of the imaging device and is obtained in advance, and identifies the portable terminal located near the candidate imaging device, and generates the second identifier of the data size depending on the number of the portable terminal identified,
wherein the detecting unit, in the control device authenticates the portable terminal when detecting that the second identifier is presented visually by the portable terminal using the image captured by the imaging device chosen to be the candidate by the generating unit.

5. The information processing system according to claim 1, including a plurality of the imaging devices,
wherein the control device further includes an operation detecting unit that detects a predetermined user operation based on the image captured by the imaging device,
wherein the detecting unit, authenticates the portable terminal when detecting that the second identifier is presented visually by the portable terminal based on the image captured by the imaging device which has captured the image of the predetermined user operation detected by the operation detecting unit.

6. The information processing system according to claim 1,
wherein the control device further includes a storage unit that stores the first identifier of the portable terminal whose the second identifier has been detected,
wherein the information processing system further comprises a managing device that determines whether content may be provided to the portable terminal based on the first identifier stored in the storage unit.

7. The information processing system according to claim 6, wherein the control device further includes a deleting unit that deletes the first identifier from the storage unit, the first identifier deleted by the deleting unit, is the first identifier of the portable terminal in which cannot be obtained again the second identifier.

8. The information processing system according to claim 6, wherein the control device includes deleting unit, for deleting from the storage unit, the first identifier when an elapsed time since the first identifier was stored exceeds a predetermined time.

9. The information processing system according to claim 6,
wherein the storage unit, stores an imaging device identifier to identify the imaging device which has captured the image from which the second identifier of the portable device has been detected, the imaging device identifier being associated with the first identifier of the portable terminal,
wherein the control device further includes a deleting unit that deletes a combination of the first identifier and the imaging device identifier from the storage unit, when a positional relation between the portable terminal having the first identifier being stored in the storage unit and the imaging device having the imaging device identifier being associated with the first identifier no longer meets a predetermined condition.

10. The information processing system according to claim 6, comprising a plurality of the portable terminals,
wherein the control device includes a function to determine whether permit communication of the content between the portable terminals based on the first identifier stored in the storage unit,
wherein the portable terminal further includes a transmitting and receiving unit that communicates the content with the other portable terminal for which communication of the content has been permitted when the control device permits communication of the content because the first identifier is stored in the storage unit.

11. The information processing system according to claim 1, wherein the portable terminal further includes a display screen in which a character string or an image representing the second identifier is displayed by the presenting unit.

12. The information processing system according to claim 1, wherein the portable terminal further includes a light source in which blinked in a pattern based on the second identifier by the presenting unit.

13. The information processing system according to claim 1, further comprising a projection device that projects a projected image within the imaging area of the imaging device,
wherein the detecting unit detects the second identifier from an area showing the projected image in the image captured by the imaging device.

14. A portable terminal comprising:
a transmitting unit that transmits terminal information including a first identifier which is identification information to a control device which is a predetermined destination of communication;
an obtaining unit that obtains from the control device a second identifier different from the first identifier; and
a presenting unit that presents visually the second identifier obtained by the obtaining unit.

15. A control device comprising:
a generating unit that generates, using terminal information transmitted from a portable terminal, a second identifier to identify the portable terminal that has transmitted the terminal information;
a replying unit that replies the second identifier generated by the generating unit to the portable terminal which has transmitted the terminal information in which the second identifier is based on; and
a detecting unit that authenticates the portable terminal when detecting that the second identifier is visually presented by the portable terminal based on an image captured by an imaging device that captures the image of a predetermined imaging area.

16. A control method comprising:
generating, using terminal information transmitted from a portal terminal that transmits the terminal information including a first identifier which is identification information, a second identifier to identify the portable terminal which has transmitted the terminal information;
replying the second identifier to the portable terminal which has transmitted the terminal information which the second identifier is based on; and
authenticating the portable terminal when it is detected that the second identifier is visually presented by the portable terminal based on an image captured by an imaging device that captures the image of a predetermined imaging area.

17. A non-transitory program storage medium that stores a computer program causing a computer to execute:
generating, using terminal information transmitted from a portal terminal that transmits the terminal information including a first identifier which is identification information, a second identifier to identify the portable terminal which has transmitted the terminal information;
replying the second identifier to the portable terminal which has transmitted the terminal information which the second identifier is based on; and
authenticating the portable terminal when it is detected that the second identifier is visually presented by the portable terminal based on an image captured by an imaging device that captures the image of a predetermined imaging area.
